(19) United States
(12) Patent Application Publication
(10) Pub. No.: US 2026/0229140 A1
(43) Pub. Date: Aug. 6, 2026

(54) INFORMATION PROCESSING DEVICE, INFORMATION PROCESSING METHOD, AND INFORMATION PROCESSING PROGRAM

(71) Applicants: OMRON CORPORATION, Kyoto (JP); THE UNIVERSITY OF TOKYO, Tokyo (JP)

(72) Inventors: Kota ARAI, Tokyo (JP); Yutaro HIRAO, Tokyo (JP); Takuji NARUMI, Tokyo (JP); Tomohiko NAKAMURA, Tokyo (JP); Shinnosuke TAKAMICHI, Tokyo (JP); Shigeo KADOMURA YOSHIDA, Tokyo (JP)

(73) Assignees: OMRON Corporation, Kyoto (JP); THE UNIVERSITY OF TOKYO, Tokyo (JP)

(21) Appl. No.: 19/152,264

(22) PCT Filed: Feb. 1, 2024
(86) PCT No.: PCT/JP2024/003373

§ 371 Date: Jul. 30, 2025

(30) Foreign Application Priority Data
Feb. 3, 2023 (JP) 2023-015722
Jun. 7, 2023 (JP) 2023-094415

(51) Int. Cl. G09B 15/00; G09B 5/02; G10G 1/00; G10H 1/00

(52) U.S. Cl. CPC G09B 15/00; G09B 5/02; G10G 1/00; G10H 1/00; G10H 2210/031

(57) ABSTRACT

An information processing device generates a first feature vector from data representing the subject timbre. The information processing device calculates a second feature vector representing a figure from the first feature vector representing the subject timbre, on the basis of a result of association of the first feature vector to the second feature vector. The information processing device generates a figure representing the subject timbre from the second feature vector.

### TECHNICAL FIELD

The present disclosure relates to an information processing device, an information processing method, and an information processing program.

### BACKGROUND ART

There are known conventional techniques for visualizing sound pitch (also called pitch) or rhythms (see, for example, Literature 1(Buck, Michael William, “The Efficacy of SmartMusic Assessment as a Teaching and Learning Tool” (2008). Dissertations. 1136. [searched on Feb. 1, 2023], the Internet <URL: https://aquila.usm.edu/dissertations/1136>), Literature 2(Estefan Cano, Christian Dittmar, and Sascha Grollmisch, “Songs2See: Learn to Play by Playing”, In 12th International Society for Music Information Retrieval Conference (ISMIR2011). Miami, 2231-2240. [searched on Feb. 1, 2023], the Internet <URL: https://www.songs2see.com/>, the Internet <URL: https://www.aes.org/e-lib/online/browse.cfm?elib=15762>), and Literature 3 (Oy. 2020. Yousician|Learn Guitar, Piano, Ukulele With The Songs you Love. [searched on Feb. 1, 2023], the Internet <URL: https://yousician.com/>).). There also are known techniques for evaluating or visualizing timbres (see, for example, Literature 4 (Knight, Trevor, Finn Upham, and Ichiro Fujinaga. “The potential for automatic assessment of trumpet tone quality.” ISMIR. 2011. [searched on Feb. 1, 2023], the Internet <URL: https://archives.ismir.net/ismir2011/paper/000102.pdf>), Literature 5 (Oriol Romani Picas, et al. 2015. A real-time system for measuring sound goodness in instrumental sounds. In Audio Engineering Society Convention 138. Audio Engineering Society. [searched on Feb. 1, 2023], the Internet <https://repositori.upf.edu/handle/10230/32131>), Literature 6 (Sergio Giraldo, et al. 2019. Automatic assessment of tone quality in violin music performance. Frontiers in Psychology 10 (2019), 334. [searched on Feb. 1, 2023], the Internet <URL: https://www.frontiersin.org/articles/10.3389/fpsyg.2019.00334/full>), and Literature 7 (Naoki Kimura, et al. 2020. SonoSpace. In Proceedings of the 28th ACM International Conference on Multimedia. Association for Computing Machinery (ACM), NewYork, NY, USA, 367-374. [searched on Feb. 1, 2023], the Internet <URL: https://www.researchgate.net/publication/345498954_SonoSpace_Visual_Feedback_of_Timbre_with_Unsupervised_Learning>)).

### SUMMARY OF INVENTION

### Technical Problem

The present disclosure aims to convert timbres into figures on the basis of users' perception.

### Solution to Problem

To achieve the above objective, an information processing device according to the present disclosure is an information processing device that generates a first feature vector from data representing a subject timbre, calculates a second feature vector representing a figure from the first feature vector representing the subject timbre on the basis of a result of association of the first feature vector with the second feature vector, generates a figure representing the subject timbre from the second feature vector, and outputs the generated figure.

An information processing method according to the present disclosure is an information processing method implemented by a computer to perform processing including: generating a first feature vector from data representing a subject timbre; calculating a second feature vector representing a figure from the first feature vector representing the subject timbre, on the basis of a result of association of the first feature vector with the second feature vector; generating a figure representing the subject timbre from the second feature vector; and outputting the generated figure.

An information processing program according to the present disclosure is an information processing program for causing a computer to perform processing including: generating a first feature vector from data representing a subject timbre; calculating a second feature vector representing a figure from the first feature vector representing the subject timbre, on the basis of a result of association of the first feature vector with the second feature vector; generating a figure representing the subject timbre from the second feature vector; and outputting the generated figure.

### Advantageous Effects of Invention

With an information processing device, an information processing method, and an information processing program of the present disclosure, it is possible to convert timbres into figures on the basis of users' perception.

### BRIEF DESCRIPTION OF DRAWINGS

FIG. 1 is a diagram for explaining the present embodiment.

FIG. 2 is a diagram for explaining the present embodiment.

FIG. 3 is a diagram for explaining the present embodiment.

FIG. 4 is a diagram for explaining the present embodiment.

FIG. 5 is a diagram for explaining the present embodiment.

FIG. 6 is a diagram for explaining the present embodiment.

FIG. 7 is a diagram for explaining the present embodiment.

FIG. 8 is a diagram for explaining the present embodiment.

FIG. 9 is a table for explaining the present embodiment.

FIG. 10 is a diagram for explaining the present embodiment.

FIG. 11 is a diagram for explaining the present embodiment.

FIG. 12 is a diagram for explaining the present embodiment.

FIG. 13A is a block diagram showing a hardware configuration of an information processing device according to the present embodiment.

FIG. 13B is a block diagram showing a hardware configuration of the information processing device according to the present embodiment.

FIG. 13C is a diagram illustrating an example of a map on which first feature vectors are projected.

FIG. 13D is a diagram for explaining a map on which first feature vectors of a plurality of sounds including representative sounds are projected.

FIG. 13E is a diagram showing an example of figure candidates displayed on a touch panel display 4.

FIG. 13F is a diagram for explaining a relationship between figures and second feature vectors.

FIG. 13G is a diagram for explaining a method of interpolating an already obtained association result.

FIG. 13H is an example of a display screen for acquiring a figure corresponding to a sound different from the representative sounds.

FIG. 13I is a flowchart illustrating an example of a processing routine to be executed by the information processing device.

FIG. 13J is a flowchart illustrating an example of a processing routine to be executed by the information processing device.

FIG. 13K is a flowchart illustrating an example of a processing routine to be executed by the information processing device.

FIG. 13L is a diagram for explaining a correspondence between a map on which first feature vectors of a plurality of timbres are projected, and figures.

FIG. 13M is a diagram for explaining a correspondence between a map on which first feature vectors of a plurality of timbres are projected, and figures.

FIG. 14 is a chart for explaining the present embodiment.

FIG. 15 is a chart for explaining the present embodiment.

FIG. 16 is a chart for explaining the present embodiment.

FIG. 17 is a chart for explaining the present embodiment.

FIG. 18 is a chart for explaining the present embodiment.

FIG. 19 is a chart for explaining the present embodiment.

FIG. 20 is a chart for explaining the present embodiment.

FIG. 21 is a chart for explaining the present embodiment.

FIG. 22 is a chart for explaining the present embodiment.

FIG. 23 is a chart for explaining the present embodiment.

FIG. 24 is a chart for explaining the present embodiment.

FIG. 25 is a chart for explaining the present embodiment.

FIG. 26 is a chart for explaining the present embodiment.

FIG. 27 is a chart for explaining the present embodiment.

FIG. 28 is a chart for explaining the present embodiment.

FIG. 29 is a chart for explaining the present embodiment.

FIG. 30 is a chart for explaining the present embodiment.

FIG. 31 is a chart for explaining the present embodiment.

FIG. 32 is a chart for explaining the present embodiment.

FIG. 33 is a chart for explaining the present embodiment.

FIG. 34 is a chart for explaining the present embodiment.

FIG. 35 is a chart for explaining the present embodiment.

FIG. 36 is a chart for explaining the present embodiment.

FIG. 37 is a chart for explaining the present embodiment.

FIG. 38 is a chart for explaining the present embodiment.

FIG. 39 is a chart for explaining the present embodiment.

FIG. 40 is a chart for explaining the present embodiment.

FIG. 41 is a chart for explaining the present embodiment.

FIG. 42 is a chart for explaining the present embodiment.

FIG. 43 is a chart for explaining the present embodiment.

FIG. 44 is a chart for explaining the present embodiment.

FIG. 45 is a chart for explaining the present embodiment.

FIG. 46 is a chart for explaining the present embodiment.

FIG. 47 is a chart for explaining the present embodiment.

FIG. 48 is a chart for explaining the present embodiment.

FIG. 49 is a chart for explaining the present embodiment.

FIG. 50 is a chart for explaining the present embodiment.

FIG. 51 is a chart for explaining the present embodiment.

FIG. 52 is a chart for explaining the present embodiment.

### DESCRIPTION OF EMBODIMENTS

In the following, an example of an embodiment of the present disclosure is described, with reference to the drawings. Note that, in the respective drawings, the same or equivalent components and portions are denoted by the same reference signs. Further, the dimensions and ratios in the drawings are exaggerated for convenience sake, and might be different from actual ratios.

### <Overview>

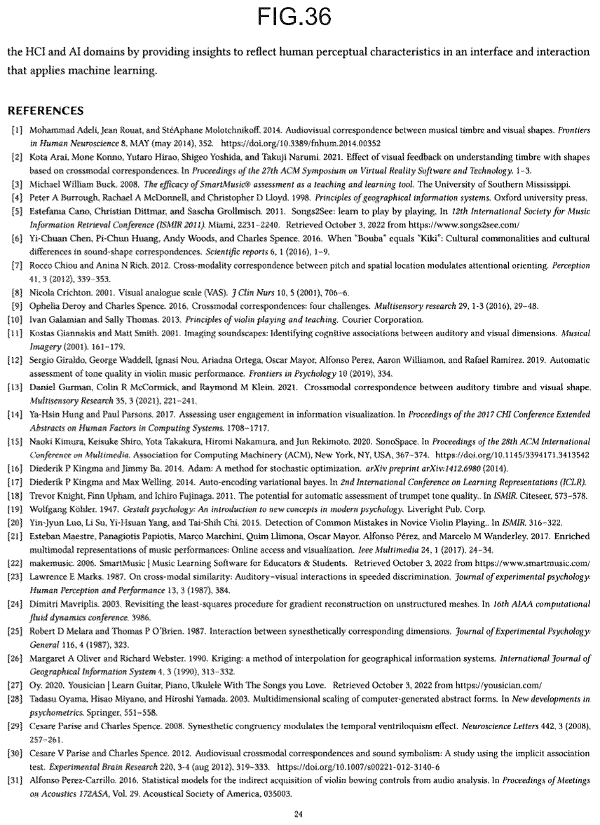

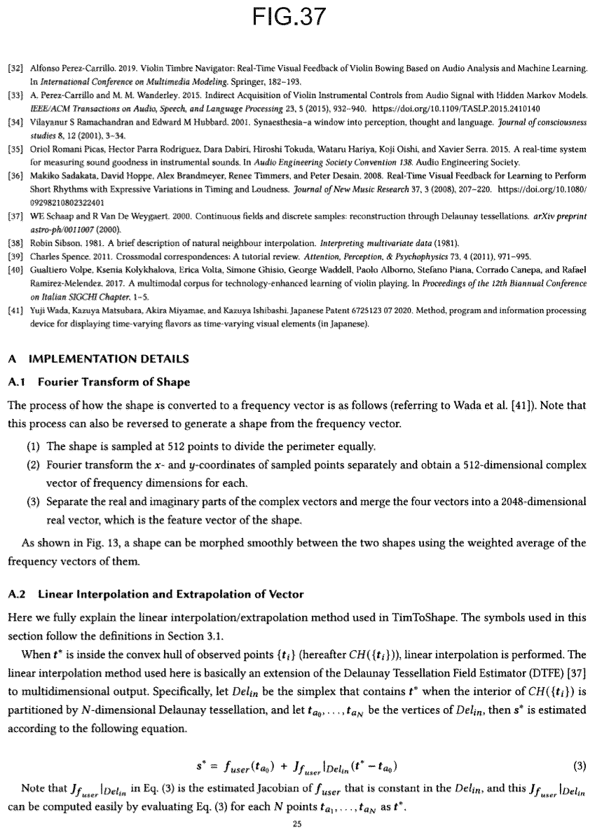

Timbre is high-dimensional and sensuous, and therefore, it is difficult for musical-instrument learners to improve their timbre. Furthermore, simply visualizing the results of unsupervised learning as the evaluation values of timbre lacks intuitive feedbacks because human perception is not taken into consideration therein. Therefore, in the present embodiment, intuitive visualization of timbre is performed using correspondences between different senses (crossmodal correspondence). In the present embodiment, a system called TimToShape that visualizes a two-dimensional shape corresponding to timbre has been developed on the basis of the correspondences between timbre input by a user and shapes. TimToShape generates a shape morphed by linear interpolation, on the basis of the position of timbre in a latent space obtained by unsupervised learning using a variational autoencoder (VAE). Further, as a result, the shape generated by TimToShape can be perceived by the musical-instrument player as feedback for the timbre. As a result, it was confirmed that shapes generated by TimToShape are perceived to correspond more to timbre than shapes presented randomly. Furthermore, a user study of six violin players revealed that TimToShape was highly evaluated in terms of visual clarity and interpretability. Note that, in the description below, the numbers in brackets “[ ]” indicate the numbers assigned to the references shown in FIGS. 36 and 37.

### 1. Introduction

Music players can convey information and feelings to the audience by appropriately changing the timbre of the sound. However, since timbre is a high-dimensional and sensuous concept, it is difficult for learners to develop the skills necessary to play the desired timbre.

Although several techniques for supporting the acquisition of timbre-related skills have been proposed [12, 35], they often require expert labeling for timbre evaluation. There is also a proposed technique using unsupervised learning that does not require manual labeling [15]. However, the feedback solely based on the results of unsupervised learning is not intuitive enough to understand the relationship between the timbre and the visual feedback. Since such visualization that is not intuitive hinders mastery, it is presumed that this could lead to the learners having difficulty bringing their timbre closer to the goal timbre [36]. Moreover, if a practice with feedback in which auditory and visual information is incongruent is continued, learners might become dependent on the feedback and unable to maintain performance when the feedback is no longer available [2].

The present embodiment focused on crossmodal correspondences (in particular, timbre-shape correspondences) to provide intuitive visual feedback on timbre to musical-instrument learners. Crossmodal correspondence is a non-arbitrary associative relationship between different modalities [39]. In auditory-visual relationships, the correspondences between timbres and visual two-dimensional shapes have been reported (for example, harsh timbres with sharp angular shapes and soft timbres with curved shapes) [1, 30]. It is assumed that the use of such correspondences makes it easier for learners to understand the relationship between timbres and feedback, and it is possible to present feedback with which it is easier to adjust the playing timbre closer to the goal. In addition, it is assumed that the use of crossmodal correspondence makes it easier for learners to recall the feedback from the timbre being played even after there is no longer any feedback, and is less likely to cause performance degradation.

To use correspondences between timbres and shapes, it is necessary to consider an intelligent method to associate a shape with an appropriate timbre. Since there are individual differences in association between timbres and shapes, it is necessary to personalize the mapping for each user. However, it is not possible to ask a user to answer the shapes that are supposed to correspond to all the timbres.

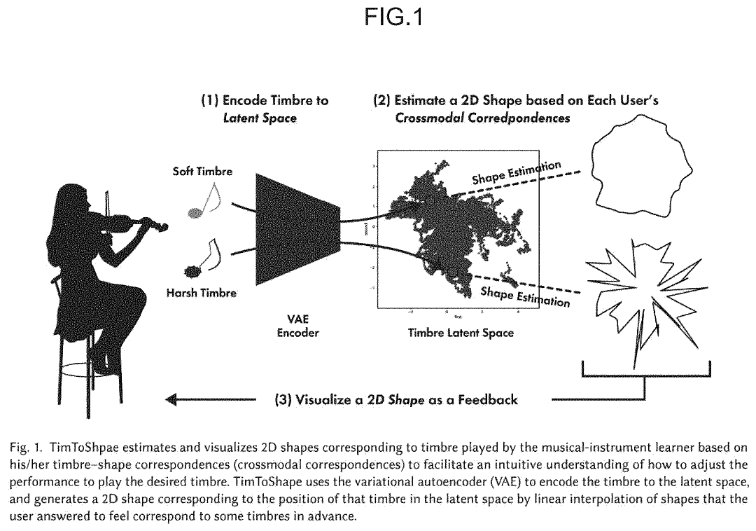

Therefore, in the present embodiment, TimToShape was developed, which is a system that generates and visualizes a two-dimensional shape corresponding to the current timbre in real time on the basis of the correspondences between some timbres and shapes answered by the user in advance (see FIG. 1). TimToShape first acquires the latent space of timbre by unsupervised learning with VAE, and then selects the optimal point from the latent space to estimate the user's timbre-shape correspondences. The user answers the shape that appears to correspond to the timbre of that point, and TimToShape linearly interpolates the answered shape to estimate the shape of the desired timbre in the latent space.

In the present embodiment, evaluation of the system was performed, focusing on the violin. Bowed stringed instruments, which produce sound by rubbing strings with a bow, have difficulty producing a beautiful timbre. In addition, the timbre quality of the violin is crucial in the overall evaluation of musical performance [10]. This system was evaluated using the violin as a use case, because of the difficulty and importance of improving techniques related to timbre quality. Furthermore, to focus only on the difference in timbre, the target timbres are limited to those of the “open A-string”, which is the simplest and most basic playing action of the violin.

To verify the effectiveness of TimToShape, two user studies were conducted. In the first study, crowdsourcing (n=75) was used to validate that the proposed system can generate shapes corresponding to any timbres of the violin's open A-string. It was found that the proposed system is more likely to make people feel that the shapes correspond to timbre than to present random shapes for timbre. The second study was conducted with six violin players to investigate the effect of visual feedback with the figures generated by this system during violin practice. Compared with a feedback system that simply visualizes the position of the timbre in the latent space like a map, the system of the present embodiment was well-received by the violin players in terms of visual clarity, ease of understanding the relationship between the timbre and feedback, and ease of recalling the feedback even after it is no longer available.

To sum up, the main contributions of the present embodiment are the following:
(1) Proposes a novel concept of visualizing timbres based on timbre-shape correspondences for supporting the practice of musical instruments.
(2) Develops TimToShape by encoding the timbre to the latent space using the VAE and generating a shape corresponding to the timbre by linear interpolation of some shapes the user answered to feel corresponding to some timbres in the latent space.
(3) Reports evaluation results and reflections on the shape estimation method of TimToShape with online user studies and on using TimToShape for practice of musical instruments with in-person user studies.

### <Prior Works>

This section reviews prior works on the computer-supported practice of musical instruments, especially the feedback method for learners playing sounds. Because our idea of visualization is based on such kind of human sensory attributes among different modalities, this section also reviews crossmodal correspondence, especially audiovisual correspondences.

### <2.1 Computer-Supported Practice of Musical Instruments>

Several studies have proposed using technology to support individual practice of playing musical instruments. Particularly, there exist many systems that support the acquisition of skills related to pitch and rhythm (3, 5, 22, 27). This is because pitch and rhythm can be quantitatively evaluated and analyzed since they are associated with some physical counterparts: pitch having fundamental frequency (the reciprocal of the period of a harmonic sound) and rhythm having note onset (the time when a note is played).

In contrast, timbre is high-dimensional and sensuous, compared with pitch and rhythm. Timbre is also associated with the physical counterpart, which is a spectral envelope of the sound, but the spectral envelope contains so many features that it is difficult to evaluate timbre quantitatively.

Despite the difficulty of evaluation of timbre, various systems have been developed to support the acquisition of skills related to timbre. Examples of evaluating the parameters of performance movements rather than evaluating timbre itself include those that directly sense and visualize the parameters of performance movements by motion tracking [21, 40], and those that indirectly estimate the parameters of performance movements from the sounds played by a support vector machine (SVM) [20], by hidden Markov Model [33], or by LSTM [31, 32]. In these examples, however, it is difficult to measure the sensitive parameters such as the amount of force with high precision, and the versatility to be applied to any musical instrument is insufficient.

In sound quality evaluation, several features are extracted from the sound, so that timbre can be modeled and evaluated. For example, Picas et al. proposed a technique to evaluate timbre using scores based on five axes, such as “timbre stability” and “timbre richness”, by selecting spectral feature amounts [35]. Giraldo et al. proposed a technique to evaluate the timbre of a violin based on semantic axes, such as dark-light, using machine learning [12]. Knight et al. proposed a method of rating the quality of trumpet timbres on a scale of 2, 3, and 7, using the SVM [18]. These studies differ from the present embodiment in that they focus on building a model that can be evaluated in a similar manner on the basis of evaluations by skilled players of each instrument. There were no evaluations of the improvement in timbre that could be achieved using these models as feedback. Moreover, these examples still have the same drawback of versatility because they require labeling by experts or careful feature selection for each instrument.

On the other hand, Kimura et al. proposed a practice support system that analyzes and visualizes timbres, and can be easily applied to various instruments without requiring labeling by experts [15]. They used unsupervised learning with the VAE to obtain the latent space of timbres as a two-dimensional space and provide a location map of the played timbre in the obtained latent space as visual feedback for learners. Although the present embodiment is based on Kimura et al.'s VAE-based method to analyze timbre, it aims to design intuitive visual feedback for timbre to facilitate performance adjustment and reduce dependence on feedback during the practice of musical instruments.

### <2.2 Crossmodal Correspondences Between Sound and Vision>

There is a natural and intuitive connection between seemingly unrelated pieces of information, such as associating sound with brightness [23] and shape with sound [19]. Such non-arbitrary associative relationships between different modalities are called “crossmodal correspondences” [39]. The Bouba-Kiki effect is a well-known example of crossmodal correspondences. For most people, the word “Bouba” is associated with a curved shape, and the word “Kiki” is associated with a sharp angular shape [34].

Various examples of crossmodal correspondences between sound and vision have been reported. For example, there are correspondences between auditory loudness and color saturation (louder sound with higher saturation) [11], auditory pitch and visual shape (lower sound with curved shape, higher sound with sharp angular shape) [25], auditory pitch and visual size (higher sound with smaller size) [29, 30], and auditory pitch and visual elevation (higher sound with higher position) [7, 25].

As an example of the correspondence between timbre and visual shapes, Parise et al. reported that sine waves were more likely to be associated with curved shapes, and square waves were more likely to be associated with sharp angular shapes [30]. Adeli et al. studied the relationship between visual shapes and instrumental timbres [1]. Harsh timbres, such as those of triangles and cymbals, were associated with sharp angular shapes. Soft timbres, such as those of the piano and marimba, were associated with curved shapes, and timbres having elements of harshness and softness together were associated with mixtures of the two kinds of shapes. Gurman et al. replicated the Adeli et al. experiment using more timbres and shapes [13]. They found the same timbre-shape correspondences as Adeli et al., and more timbre-shape correspondences (hollowness and distortion-fuzz of sound and shape). These studies showed that numerous people are consistent in the types of shapes they perceive as congruent with timbres. By using these correspondences between timbres and shapes, this system aims to provide intuitive visual feedback on timbres. While the studies presented above have examined the relationship between discretely different timbres and discretely different shapes, we need to find the corresponding shapes for continuously changing timbres. Therefore, this system estimates the correspondence of a shape to an arbitrary timbre from the correspondence of the shape to several timbres.

Although crossmodal correspondence is a characteristic shared by many people, there are individual differences due to differences in culture, experiences, and the like [6], because crossmodal correspondences are said to be based on experiences acquired in daily life. Therefore, rather than visualizing a fixed correspondence between timbre and shape, TimToShape allows the learners to customize the correspondences in the present embodiment.

### 3 Theory and Implementation

The easiest way to estimate the correspondence between timbres and shapes for each user is to ask the users to indicate the shapes they feel correspond to all timbres. However, the timbre of a musical instrument (even if it is the same instrument and played at the same pitch) changes continuously in various ways depending on how it is played. It is theoretically impossible to ask the user to answer the shapes they feel correspond to “all” timbres. Therefore, in the present embodiment, the problem of estimating the shape that the user can perceive as corresponding to any given timbre is to be solved on the basis of the user's correspondence of shape to some “representative” timbre. This will make it possible to associate any given timbre with a shape felt by the user.

### <3.1 Problem Formulation>

T⊂R^{N} is assumed to be the feature space of timbres, and f_{timbre} represents the map from raw timbre data to the feature vector of timbres. Likewise, S⊂R^{M} is assumed to be the feature space of shapes, and fₛₕₐₚₑ represents the map from raw shape data to the feature vector of shapes.

Further, tᵢ:=f_{timbre}(tᵢ) (ϵT) is assumed to be the feature space of the raw timbre data tⁱ, sᵢ:=fₛₕₐₚₑ(sᵢ) (ϵS) is assumed to be the feature space of the shape sᵢ, and fᵤₛₑᵣ:T→S represents the user's mapping function from the feature space of timbres to the feature space of shapes.

Here, the problem of “estimating the corresponding shape for any timbre from the shapes answered to some representative timbres” can be formulated as follows.

Given some observed timbre-shape pairs {(tᵢ, sᵢ: (=fᵤₛₑᵣ(tᵢ)))|tᵢϵT, sᵢϵS}, s*=fᵤₛₑᵣ(t*) is estimated for some timbres t*ϵT.

Assuming that the set of observation points {tᵢ} is an irregular grid (scattered data) and that there are no (or few) errors in the observation of {sᵢ(=fᵤₛₑᵣ(tᵢ))}, this problem can be regarded as an irregular-grid multivariate interpolation problem.

The following Sections 3.2 and 3.3 concern what was used for the feature space of timbres and shapes, respectively, and Section 3.4 concerns how this interpolation (or extrapolation) problem was solved.

### <3.2 Feature Space of Timbres>

To map timbres to the feature space T in the present embodiment, a variational autoencoder (VAE) is used, as in Kimura et al. [15]. A VAE is a machine learning model with an encoder and decoder that acquires the latent space of data through unsupervised learning [17].

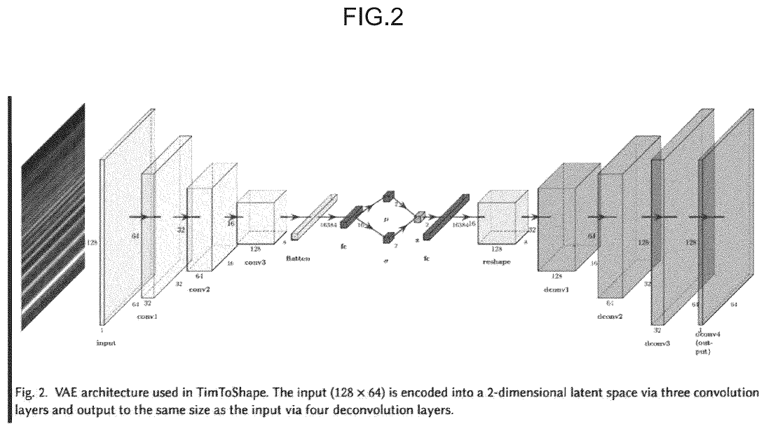

FIG. 2 shows the architecture of the VAE used. The input for the VAE is the log-mel-spectrogram (calculated with n_fft=2,048, hop length=1,024, and n_mels=128, the overall size being 128×64) of the timbre frame. The timbre frame here means the segment of the timbre to which a single shape is mapped. In the present embodiment, 66,560 samples (≈1.5 seconds) at a sampling rate of 44,100 Hz are used as one frame. Therefore, in a case where TimToShape is used in real time, frames are updated every 1,024 sample points (note that frames are overlapped). This frame length was determined to be appropriate because it is sufficiently long to allow users to listen to and associate shapes with the “representative” timbres, but not so long as to impair responsiveness in real-time use. The input for the VAE is then encoded into the two-dimensional latent space (this dimension number follows Kimura et al. [15]), and the latent vector z is decoded into the output of the same size (128×64) as the input. The VAE model was implemented using an open-source framework called Keras.

The VAE encodes the input data as a stochastic distribution rather than as a single point. This is accomplished by the encoder outputting the mean (p) and variance (o) of the distribution of the latent variable z separately, and sampling a random vector following a normal distribution N(μ, σ) by combining μ and σ, as z (this technique is called “reparameterization trick” [17]). However, since the feature vector of one timbre should be constant in this system, the mean μ of the latent variable z is adopted as the feature vector of the timbre.

### <3.3 Feature Space of Shapes>

To be used for interpolation of shapes, S (feature space of shapes) needs to satisfy the following condition.

Condition: for any two points sᵢ and sⱼ in the feature space of shapes, when parameters move on the line connecting the two points, the corresponding shape also changes smoothly from sᵢ to sⱼ.

In the present embodiment, the “frequency domain” of shapes is used as the feature space S with reference to Wada et al. [41]. A shape can be smoothly morphed between any two shapes using the frequency vectors of the two shapes. For a detailed explanation, see Appendix A.1 in FIG. 37.

### <3.4 Linear Estimation of Shape>

Next, how TimToShape estimates shapes s* for different timbres t* is described. As described in Section 3.1, this problem is an irregular-grid multivariate interpolation (or extrapolation) problem. Examples of methods that can solve this problem include nearest neighbor interpolation [4], linear interpolation (with a triangulated irregular network) [4, 37], natural neighbor interpolation [38], inverse distance weighting (IDW) [4], and Kriging (Gaussian process regression) [26].

In the present embodiment, linear interpolation and extrapolation are used. The linear estimation method was used because the calculation is relatively simple and the linear extrapolation method extrapolates observation values on the basis of the gradient on the boundary of the convex hull of the observation points, and is considered suitable for this system.

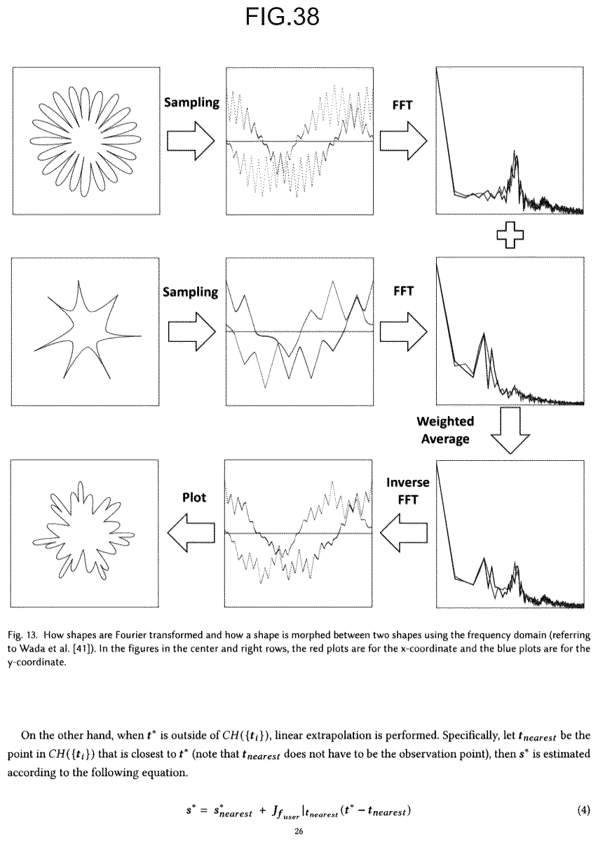

The basic idea of linear interpolation/extrapolation can be expressed as follows, where t\hat{ } represents an appropriate point in the vicinity of t*, and J_{fuser}|t\hat{ }represents the estimated Jacobian of fᵤₛₑᵣ at t\hat{ }. For a detailed explanation, see Appendix A.2 in FIGS. 37 to 39.

$$\begin{matrix}[ Math . 1 ] & \\ {{s}^{*} = {f}_{user} ( \hat{t} ) + {J}_{{f}_{user}} \vert}_{\hat{t}} ( {t}^{*} - \hat{t} ) & ( 1 )\end{matrix}$$

### <3.5 Method for Observation of User's Mapping Function>

Next, the method for observation of fᵤₛₑᵣ, which includes how to select the observation points (representative timbres) {tᵢ} and how to observe sᵢ for each tᵢ is described. Here, there is an important point to note. Although fᵤₛₑᵣ has been discussed as a deterministic function so far, it is considered that the actual human correspondence between timbres and shapes is not deterministic and has the following two properties.

Property 1. The relationship between timbres and shapes is affected by relative differences in the timbres. This means that the image of a shape for each timbre is expressed more clearly when timbres are listened to and compared than when timbres are listened to separately.

Property 2. Instead of one particular shape corresponding to one timbre, a group of shapes with similar impressions corresponds to one timbre.

Therefore, fᵤₛₑᵣ is adopted here as a “favorable” one to use in the system among the entire set of actual correspondences of the user between timbres and shapes. In a case where the following two conditions are satisfied, it is determined to be “favorable”.

Condition 1. The variation in the shape mapped to the timbres is large.

Condition 2. The mapped shape changes smoothly for the entire T.

To observe fᵤₛₑᵣ so that these conditions are satisfied, the following steps were devised.

(1) Prepare T_{dataset} as a dataset of timbres (raw timbre data) to be targeted by the system, and prepare an empty set Tᵣₑₚ.

(2) Calculate the image T_{dataset}:={f_{timbre}(t)ϵT|tϵT_{dataset}}.

(3) From T_{dataset}, select a set of N+1 points (hereinafter referred to as the set T_{farthest}) so that all points are affinely independent, and the distance of the closest two points is maximal. Then calculate the inverse image T_{farthest}:{tϵT_{dataset}|f_{timbre}(t)ϵT_{farthest}}. Timbres at these points are more likely to be a characteristic combination of timbres in the dataset, and according to Property 1, users are likely to associate shapes that greatly differ. This helps fᵤₛₑᵣ satisfy Condition 1, and therefore, these points are selected.

(4) Ask the user to listen to and compare all the timbres in T_{farthest}, and ask the user to answer the shape sᵢ that they feel corresponds to each timbre tᵢϵT_{farthest}. N+1 observation values {(tᵢ, sᵢ):=(f_{timbre}(tᵢ), fₛₕₐₚₑ(sᵢ))} are then recorded. After that, add all the observation points {tᵢ} to Tᵣₑₚ.

(5) Repeat the following processing an appropriate number of times (maximum 30 times in the present embodiment).

(a) Select one t_{farthest}. Note that t_{farthest} satisfies the following constraint condition.

$${t}_{farthest} s . t . {t}_{farthest} ∉ {T}_{rep} ⋀ {t}_{farthest} ∈ {arg max}_{t ∈ {T}_{dataset}} \{ {min}_{{t}^{′} ∈ {T}_{rep}} ‖ t - {t}^{′} ‖ \} \qquad [ Math . 2 ]$$

Then find t_{farthest} satisfying the following constraint, and request the user to listen to t_{farthest}.

$${t}_{farthest} ∈ {T}_{dataset} s . t . {f}_{timbre} ( {t}_{farthest} ) = {t}_{farthest} \qquad [ Math . 3 ]$$

(b) Display a shape s*_{farthest′} generated from s*_{farthest} estimated for t_{farthest} on the basis of the observations so far, and ask the user if he/she feels that the displayed shape s*_{farthest} already corresponds to t_{farthest}. If the user answers “yes”, (t_{farthest}, s_{farthest}) is recorded as another observation, t_{farthest} is added to Tᵣₑₚ, and the remaining steps of this loop are skipped. If this occurs three times in a row, the entire observation process is completed because the observation is sufficient. If the user says “No”, proceeds to Step (5)(c).

(c) Ask the user to search for a shape that seems to correspond to t_{farthest} near s farthest according to the following Formula (2). The J in Formula (2) is the Jacobian estimated in Formula (1), and the user moves the t_{neighbor} around t_{farthest}. In actual use, N sliders are presented, and the user manipulates t_{neighbor} by manipulating each slider. If the user finds the shape, s**_{farthest} is set as the feature vector of that shape, (t_{farthest}, s_{farthest}) is then recorded as another observation, t_{farthest} is added to Tᵣₑₚ, and the remaining steps of this loop are skipped. In other cases, proceed to Step (5)(d).

$$\begin{matrix}[ Math . 4 ] & \\ {s}^{**} = {s}^{*} + J ( {t}_{neighbor} - {t}_{farthest} ) & ( 2 )\end{matrix}$$

The reason for preparing this step is to use Property 2 to observe the fᵤₛₑᵣ without increasing the dimension of the image of T_{dataset} mapped to S by fᵤₛₑᵣ as long as possible, which may help fᵤₛₑᵣ satisfy Condition 2.

(d) As in Step (4), ask the user to answer any shape s′_{farthest} that the user feels corresponds to the timbre. Then record (t_{farthest}, s′_{farthest}) as another observation, and add t_{farthest} to Tᵣₑₚ.

The next section describes how the user answers the figures in Steps (4) and (5).

### <3.6 Process for Answering Shape for Timbre>

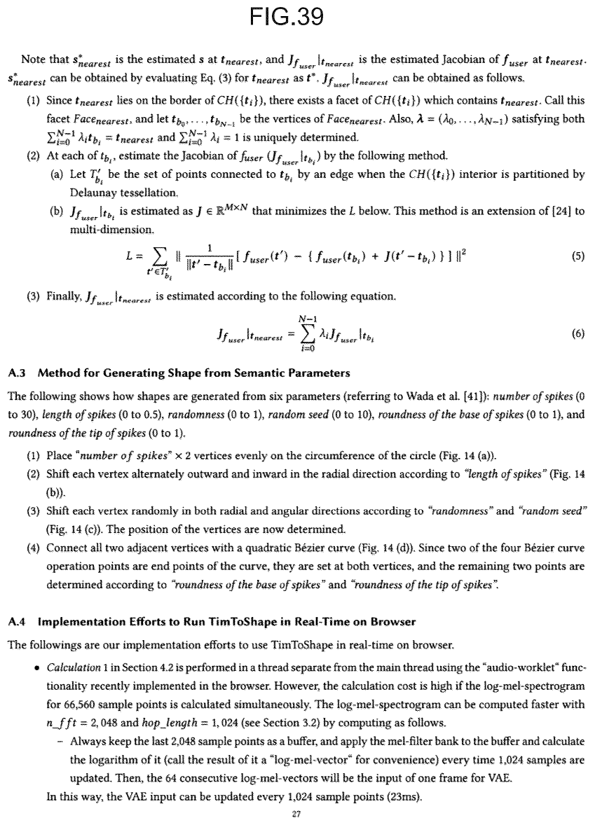

As described in Section 3.3, in the present embodiment, a frequency vector is adopted as the feature vector of a shape. However, it is almost impossible for users to manipulate the frequency vector to create a desired shape. Therefore, the present embodiment implemented a method based on Wada et al. [41] for generating shapes from semantic shape parameters (semantic parameters) to enable users to use them when answering shapes to timbres. Referring to the study by Oyama et al. [28], the following six parameters were used to generate shapes: the number of spikes (0 to 30), length of spikes (0 to 0.5), randomness (0 to 1), the random seed (0 to 10), roundness of the base of the spikes (0 to 1), and roundness of the tip of the spikes (0 to 1). For details on how to generate a shape from these parameters, see Appendix A.3 in FIG. 39.

Using the method of generating a shape from semantic parameters in this manner, users can answer the shape they feel corresponds to the timbre in the following process.

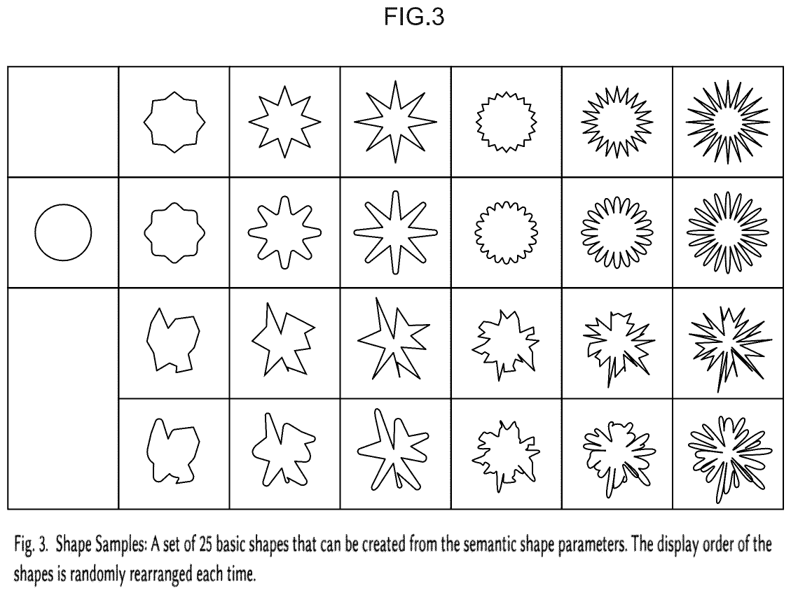

(1) Select one shape from Shape Samples (FIG. 3) that the user feels best corresponds to the timbre. The Shape Samples include 25 basic shapes that can be created from semantic parameters of shapes. This step is prepared because it is easier for users to compare several shapes and choose one from them than to think of a shape from scratch.

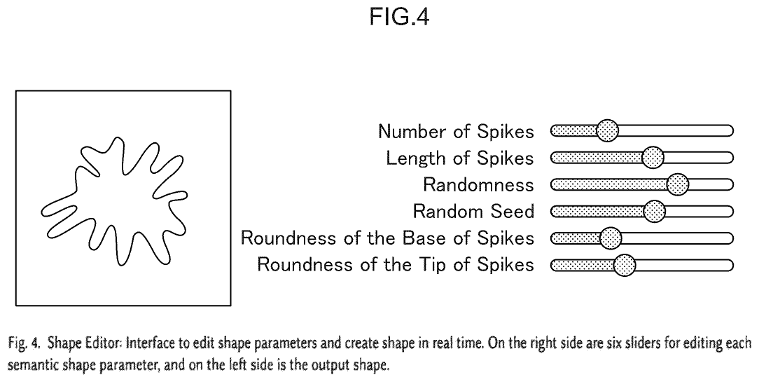

(2) Modify the shape selected in the previous step so that the user feels that the shape corresponds more to the timbre using “Shape Editor”, which allows the user to edit the semantic parameters of a shape in real time (FIG. 4).

### 4 Interface for Annotation and Visual Feedback

While the previous Section focused on the theory used in TimToShape and its implementation, this section provides an explanation related to the implementation of the interface from the practical perspective.

### <4.1 Interface for Timbre-Shape Annotation>

Sections 3.5 and 3.6 described the methodology of how to observe fᵤₛₑᵣ and briefly explained its implementation. This section concerns how they are implemented as an interface and how to use them from a user's perspective. Hereinafter, a step in which the user answers a shape to each representative timbre will be referred to as “timbre-shape annotation”.

From the user's perspective, the timbre-shape annotation is roughly divided into a step of answering shapes for the first to third timbres, and a step of answering shapes for the fourth and subsequent timbres.

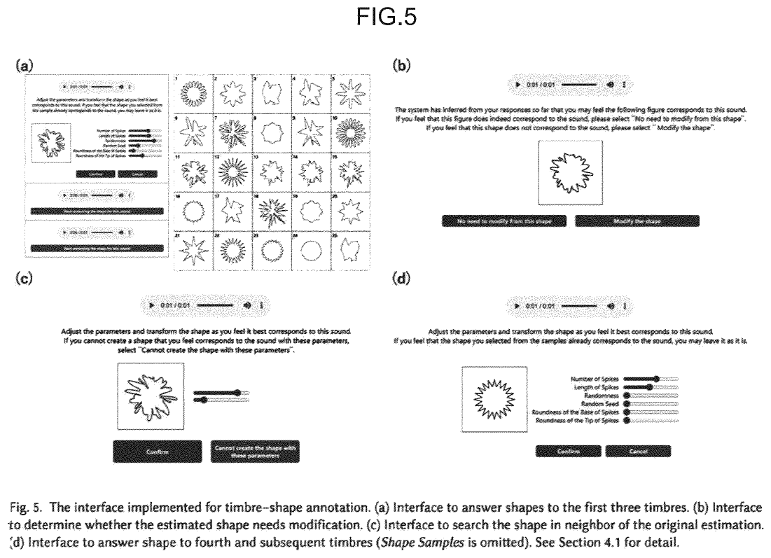

The first step, in which the user answers shapes for the first three timbres, corresponds to Step (4) in Section 3.5. The reason for the number of timbres being three is that, as explained in Section 3.2, the number (N) of dimensions of the latent space of timbres is two. In this step, the user answers a shape to each of the three timbres, following the process described in section 3.6. The interface used here is shown in FIG. 5(a), where the three timbres are displayed simultaneously, and Shape Samples are displayed on the right side. After the user selects a shape from Shape Samples, Shape Editor is displayed to allow the user to edit the shape using semantic parameters.

The second step in which the user answers shapes for the fourth and subsequent timbres corresponds to Step (5) in Section 3.5. This step includes the following three phases.

Phase 1: Verify whether the estimated shape is acceptable (FIG. 5(b)), which corresponds to Step (5)(b) in Section 3.5. Select whether modification is necessary by clicking a button. If modification is necessary, proceed to Phase 2. Otherwise, proceed to the next timbre. After this occurs three times, timbre-shape annotation is finished.

Phase 2: Verify shapes around the estimated shape (FIG. 5(c)). This corresponds to Step (5)(c) in Section 3.5. Two sliders are displayed to allow the search for the shapes around the estimated shape. If the user cannot find a shape that he/she feels corresponds to the timbre, proceed to Phase 3.

Phase 3: Answer the shape that the user feels corresponds to the timbre with Shape Samples and Shape Editor (FIG. 5(d)), following the process described in Section 3.6. Note that Shape Samples are omitted from the drawing.

### <4.2 Implementation of Real-Time Shape Feedback for Timbre>

TimToShape estimates and displays shapes in real time corresponding to the timbre input to the microphone. To achieve this, the following calculations need to be performed with low latency.

Calculation 1. Calculation of the log-mel-spectrogram of the microphone input

Calculation 2. Encoding into the latent space by the VAE

Calculation 3. Estimation of the frequency vector of a shape through linear interpolation (or extrapolation).

Calculation 4. Inverse Fourier transform of the frequency vector and drawing of the shape

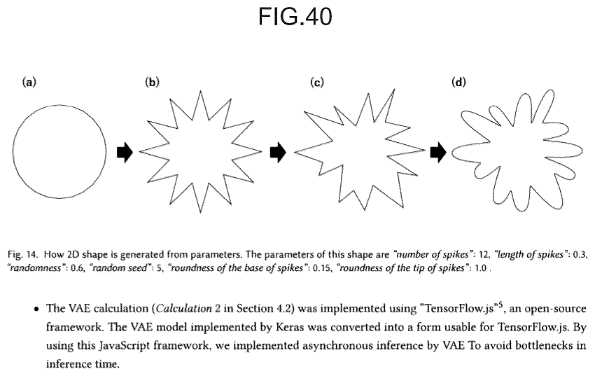

These were implemented using JavaScript (registered trademark) so as to run on a browser. Several implementation efforts were made to speed up the above calculations (see Appendix A.4 in FIGS. 39 and 40 for details). The final computation time was five to six ms for Calculation 1, was 20 to 40 ms for Calculation 2, was one to two ms for Calculation 3, and was one to two ms for Calculation 4. Overall, it took 60 ms or less from the time the last sample point of a frame was input to the microphone until it was reflected in the drawing. Furthermore, using asynchronous processing, a frame rate of about 40 fps was achieved (PC: Macbook Pro, M1, 2020 with version 12.4 of macOS Monterey, Browser: PC: Macbook Pro, M1, 2020 with version 12.4 of macOS Monterey, Browser: Google Chrome of version 106.0.5249.119).

### 5 Study 1: Congruency of Timbre and Generated Shape

Study 1 aims to verify that TimToShape can generate a shape that users feel corresponds to a timbre on the basis of each user's input of timbre-shape correspondences. An online user survey was conducted to determine whether shapes generated by TimToShape were more likely to be perceived as congruent with timbres by the participants than randomly generated shapes. Study 1 did not use TimToShape as a real-time feedback system (a shape changes dynamically) but as a system that generates one static shape for one frame (≈1.5 s) of timbre. This is because, if a shape changes dynamically, it is impossible to measure the congruency of the timbre and shape in each frame.

### <5.1 Dataset>

The timbre dataset used in Study 1 was a smartphone recording of the “open A-string” of the violin by one of the inventors of the present disclosure. The inventor is an advanced-level player who has been playing the violin for over 19 years. This dataset contains timbres of the violin's “open A-string” played with various force levels, bow positions, and bow angles, including timbres imitating those produced by a beginner as well as advanced-level player.

The recordings were made in a quiet room, using the smartphone's standard recording application (Voice Memos). The reason for the use of a smartphone was to achieve a system that works without any special equipment or application.

The recording time was approximately 20 minutes. The silent time was trimmed, frames (one frame containing 66,560 sample points) were cut out and were shifted every 500 sample points (frames overlapping), and a dataset containing a total of 90,159 frames was created.

### <5.2 Training>

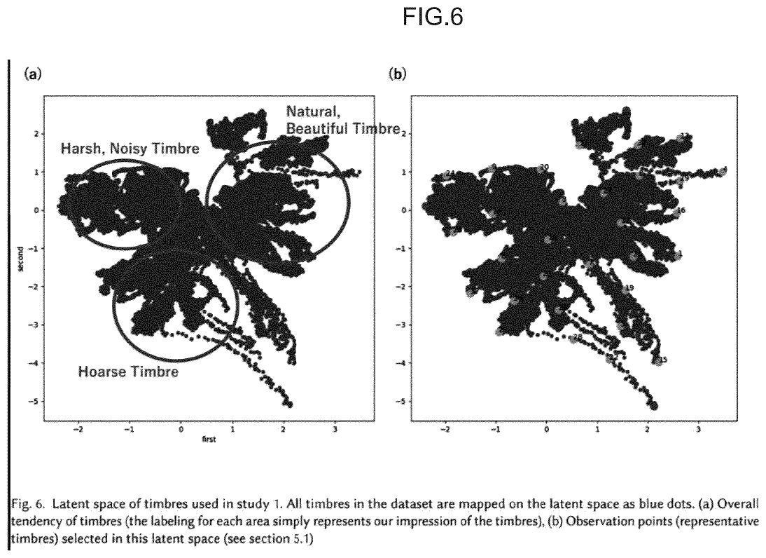

Using this timbre dataset, the unsupervised learning of the VAE described in Section 3.2 was performed. The training of the VAE was performed on a Windows (registered trademark) 10 PC with two GeForce GTX1080Ti GPUs. For validation, 20% of the dataset was used. The optimizer was Adam (learning rate: 0.001) [16], the batch size was 512, and there were a maximum of 200 training epochs. The training was automatically interrupted by early stopping based on validation loss. The resultant latent space (p of z) of timbres is shown in FIG. 6(a). Although no labeling was performed on the timbre dataset, the latent space mapping for the timbres showed a rough trend, as depicted in the drawing (note that the labeling for the areas in FIG. 6(a) simply represents our impression of the timbres as illustrated in FIG. 6).

On the basis of the method described in Section 3.5, the observation points in this latent space are shown in FIG. 6(b). The red dots are the observation points adopted in Steps (3) and (4) in Section 3.5, and the yellow dots are the observation points (representative timbres) adopted in the 30 loops in Step (5) in Section 3.5. The numbers labeled next to the yellow dots indicate their order of selection (all participants annotated shapes for timbres in this order).

### <5.3 Participants>

In Study 1, 101 participants were gathered through a crowdsourcing platform. Sixty-four participants were male, and 37 were female, with a mean age of 42.5 years and a standard deviation of 7.43. All participants were required to participate in the study on a PC and wear earphones or headphones.

### <5.4 Procedure>

This Study 1 was divided into two sessions. In the first session, the participants performed the timbre-shape annotation, following the flow described in Section 4.1. The interface was identical to that shown in FIG. 5. The timbres presented in this step correspond to the red and yellow dots in FIG. 6(b) (as mentioned in Section 5.1).

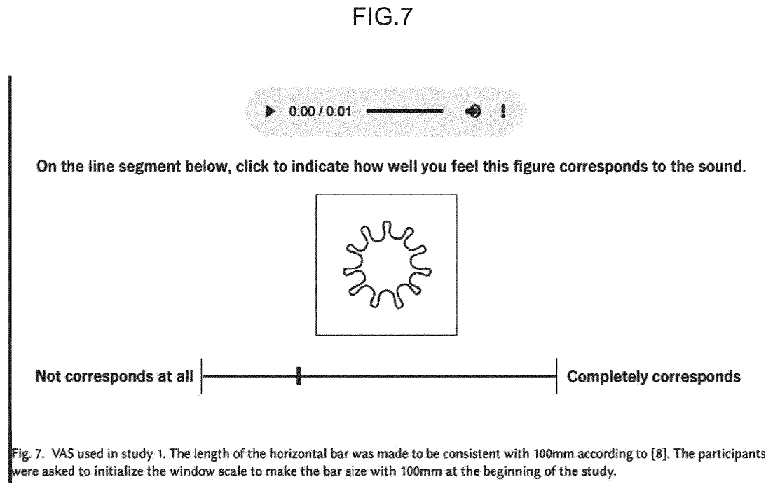

In the second session, 30 timbres were randomly selected from the dataset, and a total of 60 trials, twice for each, were conducted. The trials were conducted in random order. On each trial, either a shape generated by TimToShape or a randomly generated shape is presented along with the timbre (both shape generation methods were used once per timbre). Here, the “randomly generated shape” was generated by randomly setting the shape parameters described in Section 3.6. For the presented timbre-shape pair, the participants were asked to answer how well they felt the shape corresponds to the timbres by visual analog scale (VAS) (the left side was “not corresponding at all” while the right side was “completely corresponding”) [8]. The interface used to answer the congruency in Study 1 is shown in FIG. 7.

### <5.5 Results>

On the basis of the time taken for the entire study, data from those who took excessively short (less than 10 minutes) or long (36 minutes or more) was eliminated as inappropriate efforts, and data from 75 of 101 participants was used in the analysis. For each participant, the “congruence score” is calculated for each of the “TimToShape” and “Random” methods by the following process.

(1) For each trial, the congruency was scored from 0 (not corresponding at all) to 100 (completely corresponding), depending on the position of the participant selected in the VAS.

(2) The average of the scores of 30 trials for each method is the congruence score of the participant.

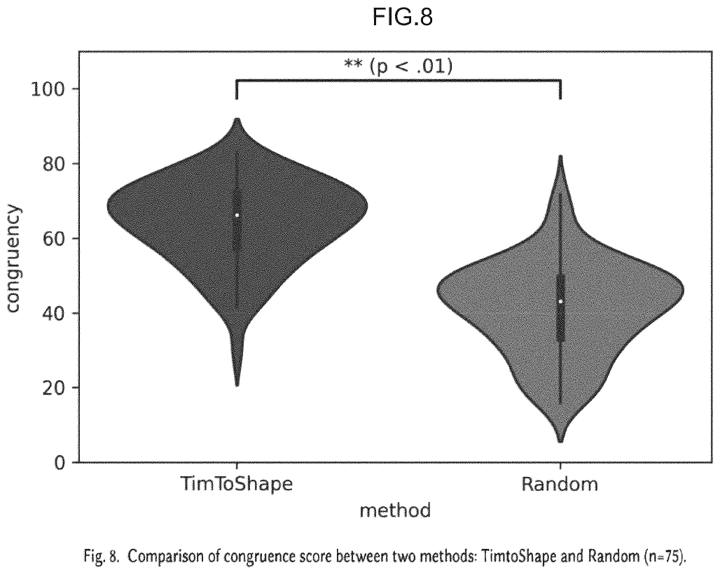

The distribution of congruence scores for all 75 participants is shown in FIG. 8. The median congruence score of “TimToShape” was 66.1 out of 100, while the median congruence score of “Random” was 43.1. A normality test (Shapiro-Wilk test) of the distribution of scores for each method showed that the distribution of “Random” can be regarded as normal (p=0.15>0.05), but that of “TimToShape” is not normal (p=0.03<0.05). Therefore, Wilcoxon signed rank test was performed using paired nonparametric data. The results showed that “TimToShape” had a significantly higher congruence score than “Random” (p=0.00<0.01, p=0.86). These results indicate that TimToShape can reliably generate shapes that correspond more to any timbre (in the dataset) than randomly generated shapes.

### 6 Study 2: Use of as Feedback System for Violin Practice

Study 2 aimed to determine the advantages, disadvantages, and other possible impacts of using TimToShape as a real-time feedback system for practicing musical instruments. Because the quantitative analysis and evaluation of timbres is difficult, the comments from the participants who used the proposed system during violin practice were mainly analyzed. Six violin players from various backgrounds were asked to practice the violin with two systems: TimToShape and a system that visualizes the positions of the timbres in the latent space as a two-dimensional map. Without revealing the violin players which of the two systems the inventors invented, the inventors asked them to practice the violin using each system, and then conducted questionnaires and interviews.

### <6.1 Dataset and Training>

Study 2 used a different dataset from the dataset described in Section 5.1. This was because this study was originally planned to be conducted using a smartphone, but because of the large computational load, TimToShape could not run in real time on a smartphone, and therefore, it was modified to be conducted using a personal computer (Macbook Pro, M1, 2020 with the version 12.4 of macOS Monterey). The recording method was almost the same as that described in Section 5.1, with the “open A-string” played with various techniques but recorded with the standard recording application (Voice Memos) of the personal computer. The total recording time was approximately 22 minutes, and frames were cut out as described in Section 5.1, creating a dataset containing 109,447 frames in total.

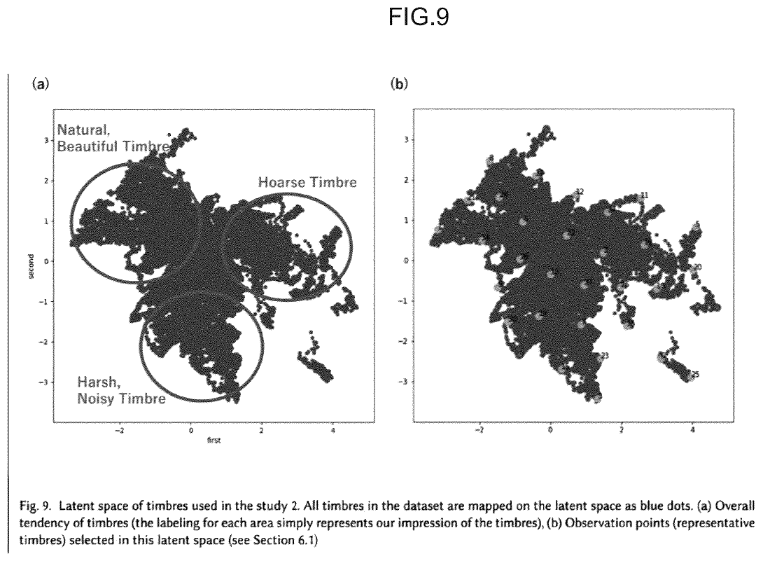

The training of the VAE was conducted in the same setting as in Section 5.2. The latent space resulting from the training is shown in FIG. 9(a) (the labeling for the areas in FIG. 9(a) simply represents the impression of the timbres). The observation points (representative timbres) selected from this latent space according to the method described in Section 3.5 are shown in FIG. 9(b) (the red dots are the observation points adopted in Steps (3) and (4) in Section 3.5, and the yellow dots are the observation points adopted in the 30 loops in Step (5) in Section 3.5).

### <6.2 Practice Goal>

The goal timbre of the participants' performance during their practice were determined. A professional violinist was asked to record a sample of an “open A-string” performance to be used as a goal timbre. This sample was recorded with the same instrument, microphone, and recording environment as when the timbres of the dataset were recorded.

The goal timbre was set to approximately 20 seconds of the 20-minute recording, during which the professional stated that he had the best-sounding performance. Here, because the goal timbre is not perfectly constant for 20 seconds, there is variance in the position of the latent space. However, when actually using TimToShape, users practice to approach one shape corresponding to a specific point in the latent space. Therefore, the average position of the goal timbre in the latent space over 20 seconds is set as the goal point expediently.

### <6.3 Feedback Systems>

For this user survey, two types of feedback systems were prepared. Both use the same VAE, but with different visualization methods.

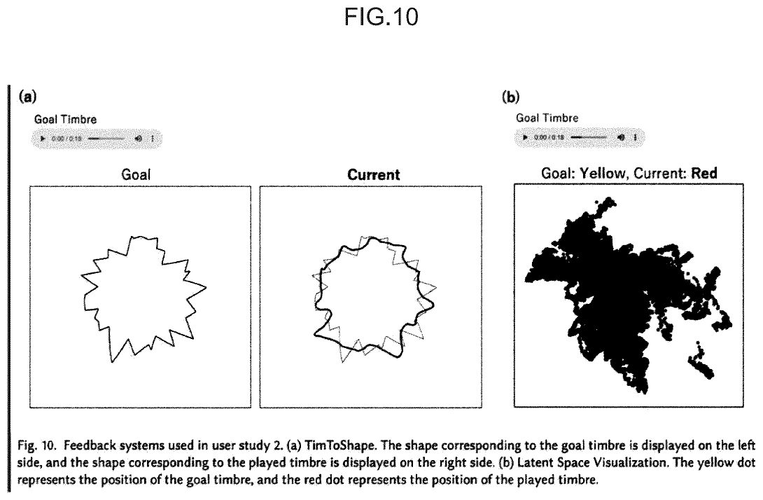

The first is our system, “TimToShape”. In actual use, a shape corresponding to the goal timbre (this shape is called the “goal shape”) and a shape corresponding to the timbre currently being played (this shape is called the “current shape”) are displayed side by side, as shown in FIG. 10(a). To make the difference in shape easier to understand, the goal shape is shown as a translucent guide in the background of the current shape.

The other is a system that visualizes the positions of the timbres in the latent space like a map (this is called “Latent Space Visualization”). As shown in FIG. 10(b), the point of the goal timbre and the point of the timbre currently being played are displayed on the map. This system is based on SonoSpace [15] by Kimura et al., but there are some differences. The differences are as follows.

The VAE used in SonoSpace calculates the position of the point for one note only after the note is played, and therefore, the position of the point is not updated in real time during the performance. However, the VAE used in TimToShape updates its inference in real time. Accordingly, in the “Latent Space Visualization”, the position of the feedback point is also updated in real time.

In SonoSpace, in addition to simply visualizing the latent space of timbres, there were several additional functions, such as allowing the user to click on a point in the latent space to play that sound or to display a waveform of the input. However, these were not implemented in this study, because pure visualization methods were to be compared.

### <6.4 Participants>

In this user survey, six violinists (P-1 to P-6) were gathered. A wide range of players from beginners to advanced-level players were gathered. The experiences of the respective instrument players are as follows.

P-1: A 55-year-old female violin player, a beginner Her daughter is learning the violin, and she has listened to the teacher's instructions together. Therefore, she has a certain degree of knowledge about the performing technique. Apart from the violin, she learned the piano for 10 years.

P-2: A 57-year-old female violin player, a beginner She has learned the violin at school for one year. Other than the violin, she has more than 50 years of piano experience, and used to be a piano teacher.

P-3: A 24-year-old male with little violin experience, an intermediate-level Viola player He started learning the Viola about nine years ago, and currently plays in an orchestra.

P-4: A 23 year-old male, an intermediate- to advanced-level violin player He took violin lessons for about 10 years in the past, and has about 18 years of experience as a violin player.

P-5: A 20 year-old male, an advanced-level violin player He took violin lessons for 15 years, and currently plays in an orchestra. In addition to that, he has 16 years of experience in piano.

P-6: A 24 year-old female, an advanced-level violin player She started taking violin lessons 20 years ago, and continues to play the violin ever since.

### <6.5 Procedure>

This study was conducted in a quiet environment similar to the environment in which the dataset was recorded. The violin and microphone used are identical to those used in the creation of the dataset. The two feedback systems and the procedure used in this study were explained to the users before the start of the study. Written informed consent was obtained from all the participants. The procedure of this study was formed with the following eight steps.

### (1) Timbre-Shape Annotation:

Timbre-shape annotation was performed according to the flow described in Section 4.1, to estimate timbre-shape correspondences of each participant.

### (2) Pre-Test:

After listening to the goal timbre, the participants conducted a one-minute trial in which they tried to reproduce the goal timbre.

### (3) Practice 1:

Practice using the first feedback system was conducted for 10 minutes. With the effects of the order taken into consideration, “TimToShape” was performed first for P-1, P-3, and P-5, and “Latent Space Visualization” was performed first for P-2, P-4, and P-6.

### (4) Acquisition Test 1:

Immediately after Practice 1, a 1-minute trial was conducted to reproduce the goal timbre with the feedback system.

### (5) Retention Test 1:

After a 10-minute break after Acquisition Test 1, a 1-minute trial of reproducing the goal timbre was conducted without the feedback system.

### (6) Practice 2:

The same practice as in Practice 1 was conducted with the other feedback system.

### (7) Acquisition Test 2:

The same trial as in Acquisition Test 1 was conducted with the other feedback system.

### (8) Retention Test 2:

After a 10-minute break after Acquisition Test 2, a 1-minute trial of reproducing the goal timbre was conducted without the feedback system. The entire study took approximately 80 minutes.

### <6.6 Measurements>

### <6.6.1 Objective Measures>

Since the latent spaces used in “Tim-ToShape” and “Latent Space Visualization” are identical, the mean distance to the goal point in the latent space is set as an objective measure of performance in the 1-minute trials in Pre-Test, Acquisition Test 1, Retention Test 1, Acquisition Test 2, and Retention Test 2. This value will be hereinafter referred to as the “Distance Error Score” (the lower the score, the better the performance).

### <6.6.2 Subjective Measures>

In addition to objective measures, semi-structured interviews and questionnaires were conducted to clarify subjective assessments during practice.
At the end of Acquisition Test 1 and Acquisition Test 2, interviews were conducted on the basis of questions about the advantages and disadvantages they felt about the feedback system, when they felt the feedback got closer to the goals, and how to achieve that. Also, using a questionnaire, the participants were asked to respond on a 7-point Likert scale, where “1” indicated high disagreement and “7” indicated high agreement, to the question about the interpretability of the feedback: “Did you understand the relationship between the sound you played and the feedback displayed?”. Regarding the engagement of the visualization system, the participants were asked to respond to six questions on VisEngage [14]. Specifically, the participants were asked to respond to a total of six questions about “Challenge”, “Discovery”, and “Interest” (two questions each).
In addition to the above, after Acquisition Test 2, the participants were interviewed about which of the two feedback systems they would prefer to use in their actual practice and why.
At the end of Retention Test 1 and Retention Test 2, the participants were asked and interviewed about the differences compared with when the feedback display was displayed.

### <6.7 Results and Discussion>

### <6.7.1 Objective Measures>

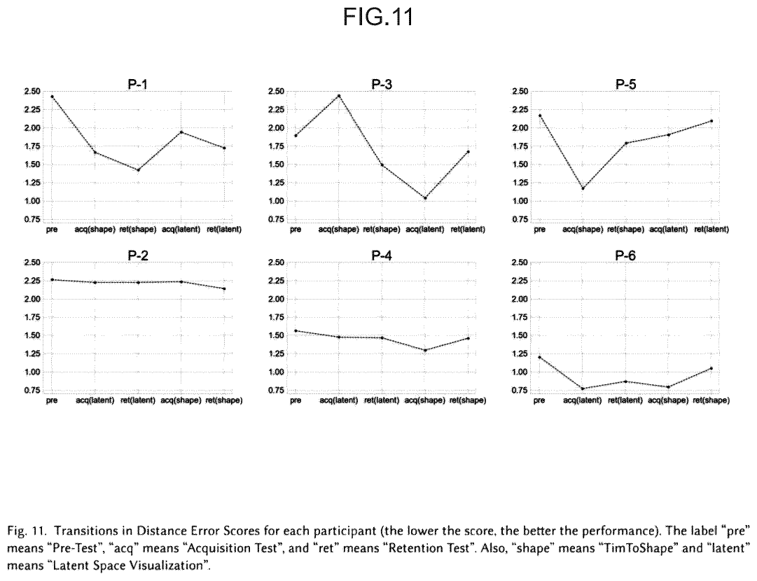

FIG. 11 shows the transitions across the “Distance Error Score” in the five tests for each of the participants. The three upper graphs are for the participants who worked on TimToShape first (P-1, P-3, P-5), and the three lower graphs are for the participants who worked on Latent Space Visualization first (P-2, P-4, P-6).

First, by analyzing the group that performed TimToShape first, it was found that P-1 and P-5 performed better in both Acquisition Test and Retention Test with TimToShape, and P-3 performed better in Acquisition Test with Latent Space Visualization but performed better with TimToShape in Retention Test.

Next, through analysis of the group that performed Latent Space Visualization first, a slight change in scores over the five tests was found, and it appeared that each person's ability in Pre-Test remained dominant until the end.

Looking only at the scores, three (P-1, P-4, P-5) performed better in Acquisition Test and five (P-1, P-2, P-3, P-4, P-5) performed better in Retention Test with TimToShape than with Latent Space Visualization. Although some score superiority was shown by TimToShape, especially in terms of retention, it would be difficult to show clear superiority of TimToShape using this objective measure because of the large overall individual differences.

### <6.7.2 Subjective Measures>

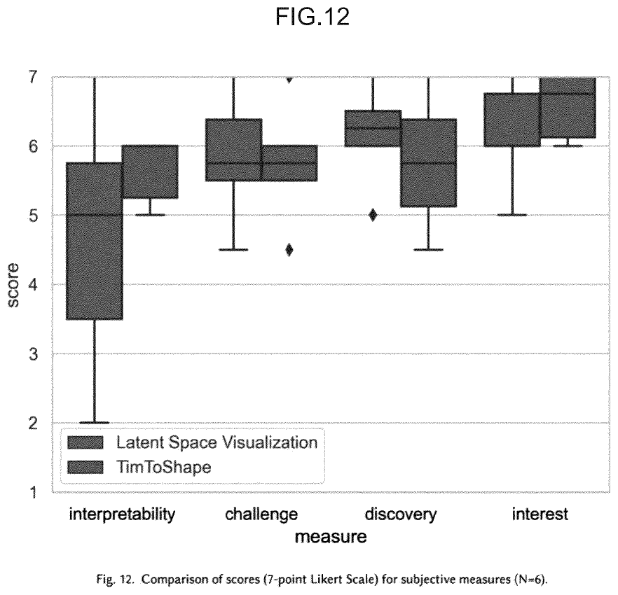

FIG. 12 shows the distributions of responses to the interpretability question and the VisEngage-based “Challenge”, “Discovery”, and “Interest” question. For “Challenge”, “Discovery”, and “Interest”, the average of the responses to the two questions was taken as one person's score. Although the statistical analysis was not performed due to the small number of participants, TimToShape tends to be higher in terms of “interpretability”. Five participants gave TimToShape a score equal to or higher than that for Latent Space Visualization.

For the question asked which of TimToShape and Latent Space Visualization they would use in practice, five participants (P1, P2, P3, P4, P6) answered TimToShape.

These results suggested that TimToShape has higher interpretability and is preferred by most people over Latent Space Visualization. From this point on, the comments in the interviews are analyzed to determine why the different methods of visualizing the latent space gave such varying impressions.

First, there are some comments on the advantages of TimToShape over Latent Shape Visualization.

“Shape was easy to understand visually and intuitively with a quick glance.” (P-2)

Two beginners (P-1, P-2) mentioned that they were so absorbed in the movement of their hands, arms, and bows that it was difficult for them to keep an eye on the feedback screen. In this context, P-2 states that she could not follow the moving dot with her eyes (in Latent Space Visualization) but that the changing shape was highly comprehensible with a quick glance (in TimToShape).

“In the map feedback (Latent Space Visualization), it was difficult to understand what the vertical and horizontal axes represented, and it was difficult to move the point as I wanted, but in the shape feedback (TimToShape), the transformation of the shape fitted my intuition and it was easy to get the hang of getting closer to the goal.” (P-6, there are similar comments from P-3 and P-4)

Several participants indicated that they had difficulty grasping the meaning of the axes of the latent space. It is interesting that, even though the same latent space was used in TimToShape, some participants found it easier to understand the relationship between the timbre and feedback simply by visualizing it through a sensory-based shape.

“When practicing with map (Latent Space Visualization), I did not feel like I was trying to bring the “sound” sounds closer to the goal sound because I was concentrating only on the movement of the dot, and I think I was not listening to my own sound very well during the practice. But practicing with shape (TimToShape), I do not know why I felt that this problem was lessened and that I could pay more attention to the sound.” (P-4, and similar comments from P-5)

It is considered that this is a comment related to the previous comment. That is, it is considered that the difficulty in interpreting the feedback caused many participants focus only on the behavior of the feedback (except for beginners). Furthermore, it is suspected that the reason this problem was reduced in TimToShape was not only because the relationship between the timbre and feedback was easier to grasp, but also because the timbres were visualized on the basis of crossmodal correspondence, which subconsciously directed the user's attention to the timbre even while looking at the shape.

“When practicing with map (Latent Space Visualization), the dot was usually not close to the goal at all, even when I tried various attempts, which was demotivating. But when practicing with shape (TimToShape), I did trial and error in various ways, and still I was able to practice without getting bored. I felt a sense of accomplishment when I got close to the target without noticing” (P-1)

This is another strength of TimToShape. Because the VAE does not consider human perception when learning, the distance in the latent space does not necessarily correspond to the distance in human perception. Therefore, a situation can arise in which two points in the latent space are extremely distant, even though they sound close as a sound. This leads to a loss of motivation, especially for beginners. However, this problem is less likely to occur with TimToShape, because figures are created on the basis of the user's perception, and even when two sounds are far apart in the latent space, if the user feels them similar to each other, the figures will be displayed close to each other.

“In the trial without feedback (Retention Test), although the figure was not displayed, I played while imagining the changing figure in real time. However, (in Latent Space Visualization,) it was difficult to imagine the position on the map in real time.” (P-5, and similar comments from P-2)

It is considered that this may be a strength of the crossmodal correspondence. By visualizing shapes that may be recalled by each user for timbres, it becomes easier to recall feedback even after it is lost.

On the other hand, the following comments were received regarding the advantages of Latent Space Visualization over TimToShape.

“Map visualization (Latent Space Visualization) seemed to have higher resolution regarding the goal and current errors.” (P-4)

“Map feedback (Latent Space Visualization) seemed to analyze more elements of timbre.” (P-5, and similar comments from P-3)

Both comments suggest that by visualizing the timbre as a shape, the amount of information is reduced compared with a case where the latent space of timbres is visualized as it is. This is not necessarily a bad thing when used for feedback, in that it reduces the cognitive load of the user, but further discussion is needed regarding the amount of information to be presented.

In addition, the following comments were received as common drawbacks to both.

“Technical advice is not presented, so sometimes it is not clear how to improve.” (P-2, and similar comments from P-1)

“Both systems require me to do a variety of trial and error to find the moment when the feedback approaches the goal by myself. If I could not find it, I would be at a loss.” (P-3)

This is a major challenge, especially for beginners using this system. TimToShape only visualizes timbres by shape, and it is easy to understand the relationship between timbres and feedback. However, any technical advice is not provided. Because technical advice varies depending on the type of instrument, attempting to solve this problem makes it impossible to build a method that is applicable to any instrument, which is the basic idea of TimToShape. Therefore, for beginners, it is recommended to use TimToShape in combination with advice from an adept professional or a system that provides feedback on technical information (for example, [32]).

Overall, this system is well received by violin players in terms of visual clarity, interpretability (easy to understand the relationship between timbres and feedback), and ease of recall (easy to recall even after the feedback is lost).

### 7 Limitation and Future Work

### <7.1 Number of Dimensions of Latent Space of Timbres>

In the present embodiment, the number of dimensions of the timbre latent space is set to “2” with reference to Kimura et al. [15]. However, further discussion of the number of dimensions of the latent space is required. If the number of dimensions of the latent space is increased, more timbre features can be reflected, which leads to a more accurate estimation of the correspondence between timbres and shapes. However, the user needs to answer shapes for timbres more times in timbre-shape annotation, which can be burdensome for the user. Further user studies should be conducted to determine the advantages and disadvantages of increasing the number of dimensions and to determine the optimal number of dimensions.

<7.2 Parameters that Constitute Shape>

As mentioned in Section 5.5, the median congruence score of TimToShape was 66.1 (out of 100). This still leaves some scope for improvement.

There are two methods to counter this problem. The first is to revisit the method of creating shapes as mentioned in Section 3.6. Currently, six semantic parameters are provided to create a shape, but these parameters may have been inadequate for creating a shape the user wants to create. Constructing a method of creating shapes more freely would improve the congruency stores.

The second is to consider parameters other than the outline of a shape. Since timbre-shape correspondences vary from person to person, some may feel a strong correspondence to factors other than shape outlines (for example, size, color, and texture pattern), as research on crossmodal correspondences between sound and vision has shown [11, 29, 30]. This method can include any element in the output, as long as the element can be linearly interpolated as a vector. This strength is leveraged to reflect elements other than the outline of the shape in the output, and shapes having high congruency to timbre are provided to a larger number of people.

Also, by increasing the number of parameters that constitute the shape, it is possible to provide more information as feedback for timbre, and alleviate the problem of the shape's low amount of information mentioned in Section 6.7.

### <7.3 Termination Condition for Timbre-Shape Annotation>

There remains scope for further study regarding the termination condition for timbre-shape annotation. Currently, the termination condition is to answer that there is no problem without modifying the estimated shape three consecutive times in Step (5)(b) in Section 3.5, or to loop Step (5) thirty times.

However, only 21 out of 75 participants in Study 1 finished with the former termination condition, and the remaining participants annotated shapes for timbres 33 times (including the first three timbres).

It is burdensome for users to perform annotation 33 times. Not only in Step (5)(b) but also in Step (5)(c), it is necessary to find the minimum number of times for the entire loop without worsening the congruence score, or to devise a method to validate the end of the loop on the basis of the size of the shape modification in the step.

### <7.4 Application for Different Timbres and Environments>

In the present embodiment, TimToShape was limited to use with the timbre of “open A-string” of the same violin. However, this method can be easily applied to any timbre of any instrument, as long as there is a dataset of the timbres.

In the future, datasets of timbres of various instruments in various recording environments will be created, and a system using these datasets that can be used with any instrument anywhere will be built.

### 8 Conclusion

The present embodiment has proposed TimToShape, which is a system that can visualize any timbres with two-dimensional shapes aligned with a person's perception, on the basis of the fact that there is a crossmodal correspondence between timbres and shapes. TimToShape aims to provide feedback that makes it easier for humans to understand the relationship between timbres and feedback in musical instrument practice. TimToShape acquires a latent space of timbres through unsupervised learning by the VAE. By asking each user to annotate shapes for some points in the latent space, it is possible to estimate a shape for any point in the latent space with linear interpolation. First, to verify the shape estimation method, a user survey (n=75) via crowdsourcing was conducted, and it was found that shapes with significantly higher congruency to the timbres than that of randomly generated shapes can be generated. Next, to verify the effectiveness of this system used as feedback for musical instrument practice, a user study with six violin players was conducted. As a result, it was found that visualization by TimToShape was more comprehensible at a glance, was easier to understand the relationship between the timbre and the feedback, and was easier to recall the feedback even after the feedback was lost, compared with the case of simply visualizing the position of the timbre in the latent space (like a map). In the future, to further improve congruency, elements other than shape outlines will be included in visualization, and, to enhance generalization performance for various instruments and environments, datasets of other timbres will be created. It is expected that, by providing insights to reflect human perceptual characteristics in an interface and interaction that applies machine learning as above, this work will inspire synergy between human-computer interaction (HCI) and AI domains.

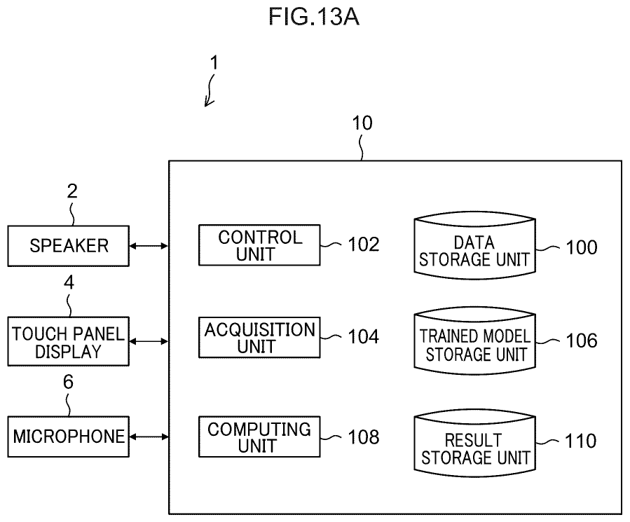

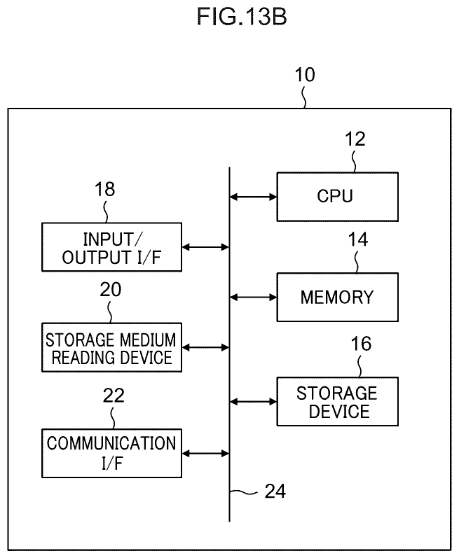

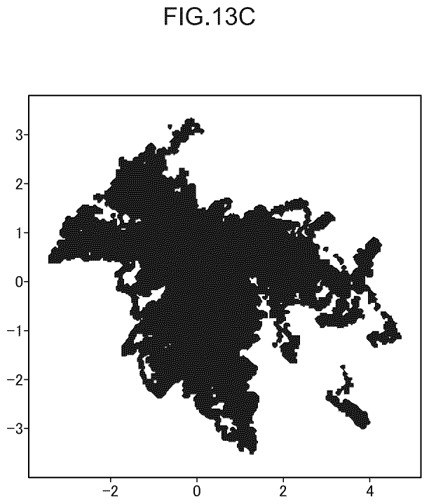

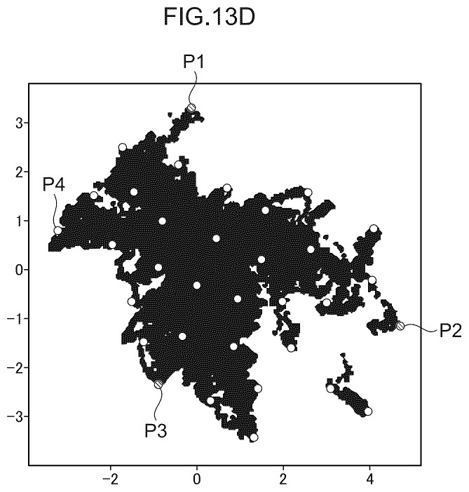

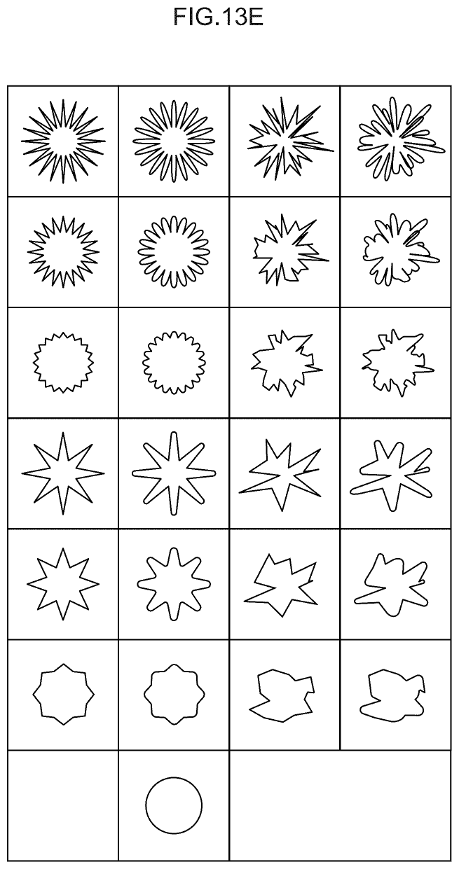

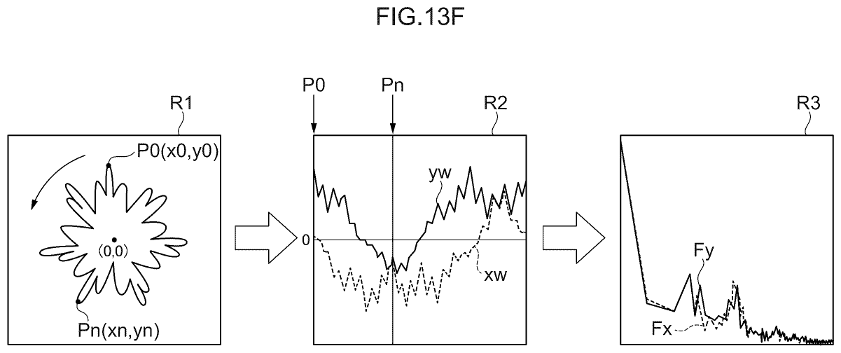

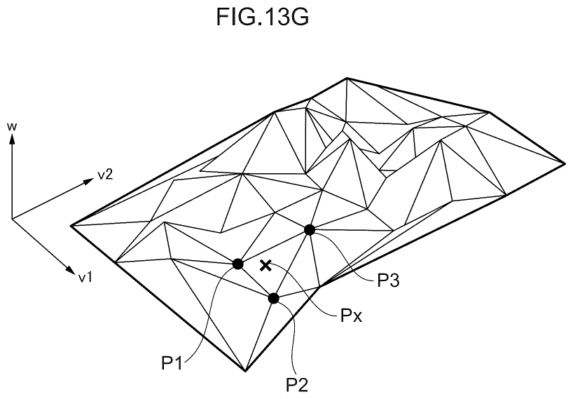

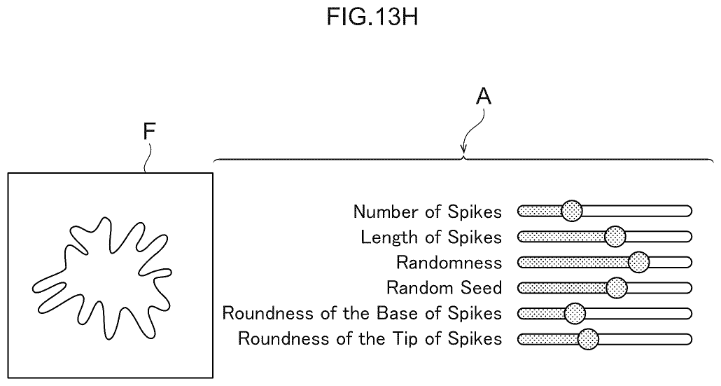

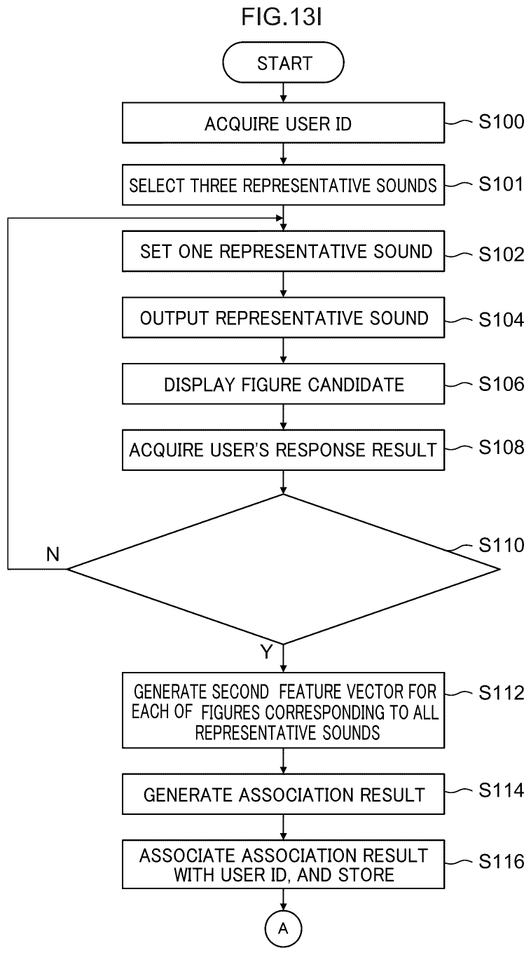

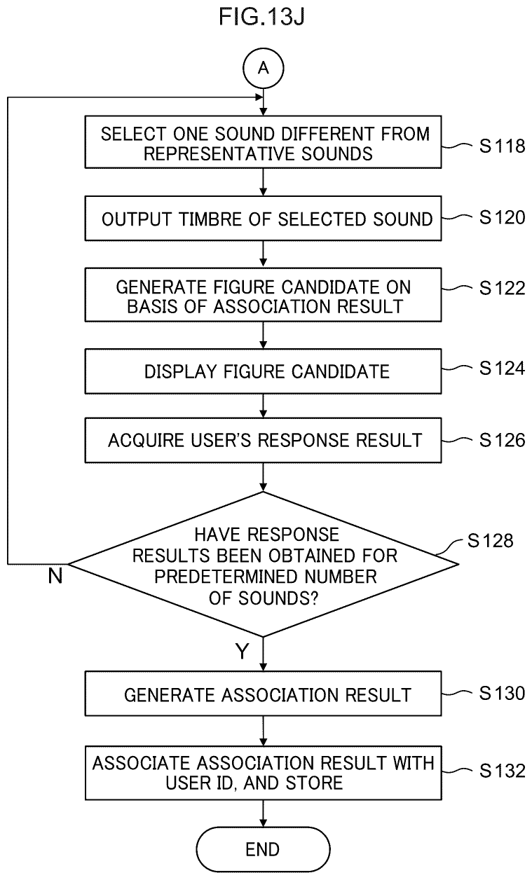

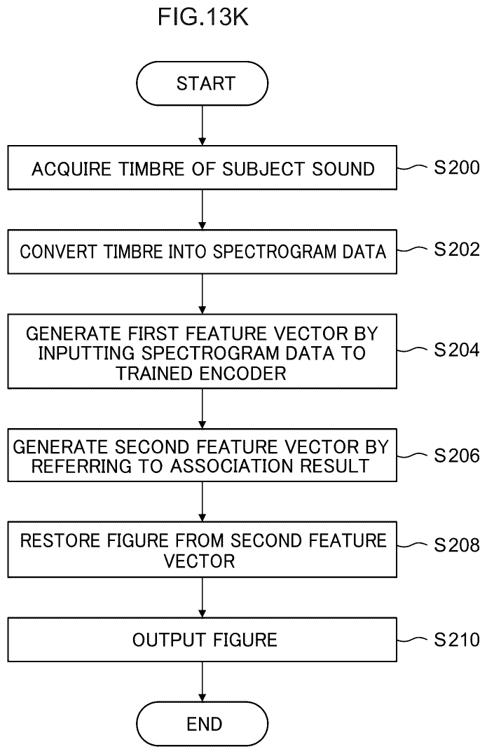

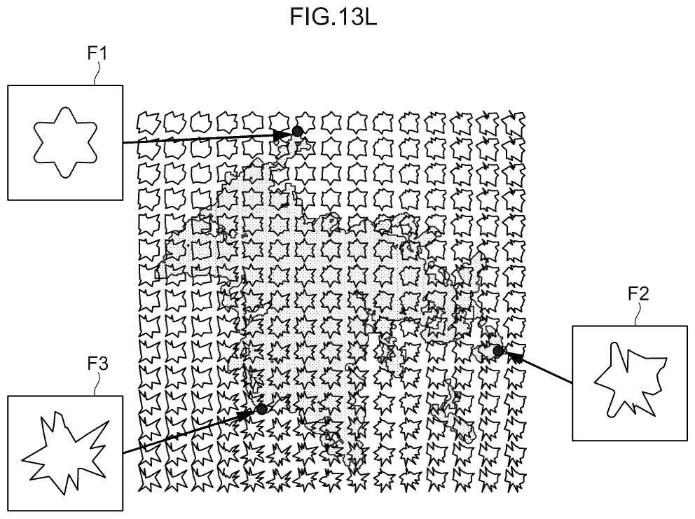

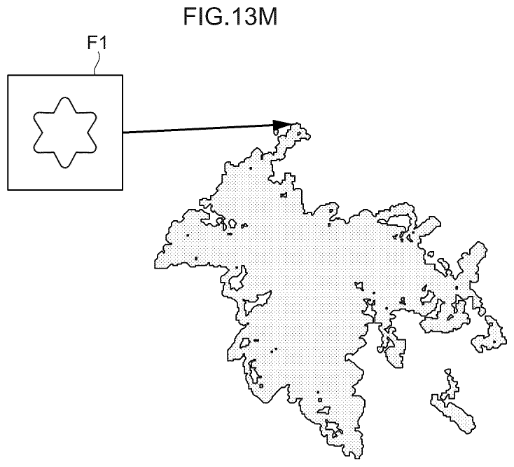

FIG. 13A is a block diagram of a schematic configuration of an information processing system 1 according to the present embodiment. As shown in FIG. 13A, the information processing system 1 includes a speaker 2 that is an example of the sound output unit, a touch panel display 4 that is an example of the display unit, a microphone 6, and an information processing device 10.

The speaker 2 outputs sound, under the control of the information processing device 10.

The touch panel display 4 displays an image, under the control of the information processing device 10. The touch panel display 4 also receives a user's operation. Note that a case where the display unit included in the information processing device 10 is the touch panel display 4 is described as an example in the present embodiment, but it is not limited to this. For example, a device different from the touch panel display 4 may be adopted as long as the device is capable of displaying an image and receiving an operation on the displayed image.

The microphone 6 acquires sound.

The information processing device 10 converts a timbre into a figure on the basis of the user's perception, using a method as described above. FIG. 13B is a block diagram showing the hardware configuration of the information processing device 10 according to the present embodiment. As shown in FIG. 13B, the information processing device 10 includes a central processing unit (CPU) 12, a memory 14, a storage device 16, an input/output interface (I/F) 18, a storage medium reading device 20, and a communication I/F 22. The respective components are communicably connected to one another via a bus 24.

The storage device 16 stores an information processing program for executing each of the processes described later. The CPU 12 is a central computing unit, and executes various programs, and controls the respective components. That is, the CPU 12 reads a program from the storage device 16, and executes the program, using the memory 14 as a work area. The CPU 12 performs the above-described various types of arithmetic processing in accordance with the programs stored in the storage device 16.

The memory 14 is formed with a random access memory (RAM), and, as a work area, temporarily stores a program and data. The storage device 16 is formed with a read only memory (ROM), and a hard disk drive (HDD), a solid state drive (SSD), or the like, and stores various programs including an operating system and various kinds of data.

The input/output I/F 18 is an interface that inputs data from an external device, and outputs data to an external device. Further, input devices for performing various kinds of inputs, such as a keyboard and a mouse, and output devices for outputting various kinds of information, such as a display and a printer, may be connected to the input/output I/F 18. A touch panel display may be adopted as an output device, and the input/output I/F 18 may be made to function as an input device.

The storage medium reading device 20 reads data stored in various kinds of storage media such as a compact disc (CD)-ROM, a digital versatile disc (DVD)-ROM, a Blu-ray disc, and a universal serial bus (USB) memory, and writes data into a storage medium, for example.

The communication I/F 22 is an interface for communicating with other devices, and a standard for Ethernet (registered trademark), FDDI, Wi-Fi (registered trademark), or the like is used.

Next, functional components of the information processing device 10 are described. As shown in FIG. 13A, the information processing device 10 functionally includes a control unit 102, an acquisition unit 104, and a computing unit 108. Further, a data storage unit 100, a trained model storage unit 106, and a result storage unit 110 are provided in a predetermined storage area in the information processing device 10. The respective functional components are implemented by the CPU 12 reading the respective programs stored in the storage device 16, loading the programs into the memory 14, and executing the programs.

The data storage unit 100 stores data representing a plurality of sounds and data representing figures. The trained model storage unit 106 stores a VAE (hereinafter also referred to simply as the trained encoder) that is an example of the trained model. The result storage unit 110 stores a result of timbre-figure association by each user.

First, the information processing device 10 acquires the result of timbre-figure association by each user.

The control unit 102 reads a plurality of representative sounds and figures stored in the data storage unit 100. Note that the present embodiment concerns an example case where there are representative sounds belonging to a group for which the user associates timbres directly with figures, and sounds for which the user corrects presented figures to associate timbres with the figures.

The control unit 102 controls the speaker 2 to output the timbres of the plurality of representative sounds, and controls the touch panel display 4 to display figure candidates corresponding to the respective timbres of the plurality of representative sounds.

As described above, in the present embodiment, data representing timbres is input to the trained encoder that is an example of the trained model, so that a two-dimensional vector is output from the trained encoder. In the present embodiment, the two-dimensional vector output from the trained encoder is referred to as the first feature vector.

Therefore, for each of the timbres, the computing unit 108 inputs spectrogram data representing the timbre to a trained autoencoder stored in the trained model storage unit 106, to generate the first feature vector corresponding to the spectrogram data representing the timbre.

The computing unit 108 then generates a map on which the first feature vector of each of the timbres is projected. The computing unit 108 then selects the first feature vectors corresponding to the timbres of the representative sounds from the first feature vectors projected on the map.

FIG. 13C is a diagram illustrating an example of the map on which the first feature vectors are projected. The plotted points shown in FIG. 13C are the two-dimensional first feature vectors generated from the respective timbres.

FIG. 13D is a diagram for explaining the map on which the first feature vectors of the representative sounds are projected. P1, P2, and P3 shown in FIG. 13D are the first feature vectors corresponding to three representative sounds. Further, each of the white-circle plotted points shown in FIG. 13D is a first feature vector corresponding to the timbre of a sound different from the three representative sounds.

First, the control unit 102 causes the speaker 2 to output the timbres of the three representative sounds corresponding to the first feature vectors represented by the plotted points P1, P2, and P3 shown in FIG. 13D. As illustrated in FIG. 13D, the respective first feature vectors of the three representative sounds are selected beforehand so that the sum of the sides of the triangle formed by the three plotted points is maximized. Each of the first feature vectors corresponding to the three plotted points is an extreme timbre, and first, figures corresponding to these timbres are answered from the user.

Therefore, the control unit 102 controls the speaker 2 to output the timbres of these three representative sounds, and controls the touch panel display 4 to display candidates for figures corresponding to the respective timbres of the three representative sounds.

FIG. 13E is a diagram showing an example of figure candidates displayed on the touch panel display 4. The control unit 102 controls the touch panel display 4 to display a plurality of figure candidates as shown in FIG. 13E.

For example, the user operates the touch panel display 4, to select figures matching the impression of the timbres of the representative sounds from among the figure candidates as shown in FIG. 13E.

The acquisition unit 104 acquires the results of responses about the figures that have been input from the user and correspond to the respective timbres of the three representative sounds.

On the basis of the response results acquired by the acquisition unit 104, the computing unit 108 associates the first feature vectors of the timbres of the three representative sounds with second feature vectors representing the figures in the response results from the user.

Here, the second feature vectors representing the figures are described.

As described above, in the present embodiment, the position of each of the points forming the figure in R1 is sampled, as illustrated in FIG. 13E For example, as illustrated in FIG. 13F, positions (x0, y0) to (xn, yn) of a plurality of points P0 to Pn in the figure are sampled in the direction of an arrow drawn in R1.

Waveform data indicating changes in the positions of a plurality of sampling points on the line forming the figure is then generated. For example, as shown in R2 in FIG. 13F, by plotting the positions (x0, y0) to (xn, yn) of the sampling points, data xw indicating changes in the x coordinate and data yw indicating changes in the y coordinate are generated. The horizontal axis in R2 in FIG. 13F corresponds to the direction of the arrow in R1 in FIG. 13E

Fourier transform is then performed on the waveform data indicating changes in the positions of the sampling points, to generate frequency vector indicating figures. For example, as shown in R3 in FIG. 13F, Fourier transform is performed on the data yw indicating changes in the y coordinate to generate a Fourier transform result Fy, and Fourier transform is performed on the data xw indicating changes in the x coordinate to generate a Fourier transform result Fx. Note that the horizontal axis in R3 in FIG. 13F indicates frequency, and the vertical axis indicates frequency intensity. As the Fourier transform results Fx and Fy are vectorized, the second feature vector representing the figure is generated. For example, a vector having the frequency intensities corresponding to the respective frequencies as components is generated as the second feature vector. In the present embodiment, 2048-dimensional second feature vectors are generated from Fourier transform results.

The computing unit 108 associates the second feature vectors of figures generated in this manner with the first feature vectors representing the timbres of the representative sounds.

Specifically, the computing unit 108 performs Fourier transform on the figures of the representative sounds obtained as the results of the responses from the user, and generates the second feature vectors that are the frequency vectors corresponding to the figures. The computing unit 108 then associates the first feature vectors representing the timbres of the representative sounds with the second feature vectors representing the figures, and generates a result of association by the user.

The computing unit 108 then obtains a result of a response about a figure matching the impression of the user for each of the timbres of a plurality of sounds different from the three representative sounds.

FIG. 13D mentioned above is also a diagram for explaining a method of selecting a plurality of sounds different from the three representative sounds. P1, P2, and P3 shown in FIG. 13D are the first feature vectors corresponding to the three representative sounds. On the other hand, each of the white-circle plotted points shown in FIG. 13D is a first feature vector corresponding to the timbre of a sound different from the representative sounds.

After the figures corresponding to the first feature vectors P1, P2, and P3 corresponding to the three representative sounds are answered, the computing unit 108 obtains the results of responses about the figures matching the timbres corresponding to the respective white-circle plotted points shown in FIG. 13D.

In this case, the computing unit 108 obtains the results of responses about the figures matching the impressions of the user, starting from the plotted point having the longest distances to the plotted points about which responses have already been obtained from the user.

For example, after the figures corresponding to the first feature vectors P1, P2, and P3 corresponding to the three representative sounds shown in FIG. 13D are answered, the computing unit 108 selects the timbre of the sound corresponding to a first feature vector P4 having the largest sum of the distances from P1, P2, and P3, as the timbre to be presented next.

The control unit 102 then controls the speaker 2 to output the timbre of the sound corresponding to the first feature vector P4 as selected by the computing unit 108. The control unit 102 also performs control so that a candidate for the figure corresponding to the timbre of the sound is displayed on the touch panel display 4.

At this point of time, the figure candidate to be displayed on the touch panel display 4 is generated by interpolating the result of association of the timbres of the three representative sounds with the figures about which the responses have already been obtained from the user.

FIG. 13G is a diagram for explaining a method of interpolating an already obtained association result. In FIG. 13G, (v1, v2) represents the first feature vectors, and w represents the second feature vectors. Note that, in FIG. 13G, the second feature vectors w are expressed in one dimension, for ease of explanation. As described above, the second feature vectors correspond to the frequency vectors obtained from figures, and therefore, the number of the dimensions of the frequency vectors is actually 2048.

For example, as shown in FIG. 13G, a case where each of the first feature vectors P1, P2, and P3 corresponding to the three representative sounds is associated with a second feature vector is discussed herein. In this case, the computing unit 108 estimates the second feature vector corresponding to the first feature vector Px in FIG. 13G, from the result of association of the three first feature vectors P1, P2, and P3 corresponding to the three representative sounds with the second feature vectors. This estimation can be performed by the known Delaunay triangulation.

Accordingly, the computing unit 108 associates the first feature vector of the timbre of the sound different from the representative sounds with a provisional second feature vector by interpolating the result of association of the timbres of the three representative sounds with the figures. The computing unit 108 then generates a candidate for the figure corresponding to the timbre of the sound different from the representative sounds, on the basis of the provisional second feature vector.

The control unit 102 then controls the speaker 2 to output the timbre of the sound different from the timbres of the three representative sounds, and controls the touch panel display 4 to display the candidate for the figure corresponding to the timbre different from the timbres of the three representative sounds.

In this case, the control unit 102 controls the touch panel display 4 to display a screen as shown in FIG. 13H, for example. A figure candidate F shown in FIG. 13H is displayed on the touch panel display 4, and a bar A for correcting the shape of the figure candidate F is also displayed on the touch panel display 4. Thus, the shape of the figure candidate F corresponding to the timbre different from the timbres of the representative sounds can be corrected by the user.

For example, the user manipulates the touch panel display 4, to correct the shape of the figure candidate F as shown in FIG. 13H, and select a figure matching the impression of the presented timbre.

The acquisition unit 104 acquires the result of response about the figure that has been input from the user and corresponds to the timbre.

On the basis of the result of the response about the figure corresponding to the timbre different from the timbres of the representative sounds, the computing unit 108 associates the first feature vector of the timbre different from the timbres of the representative sounds with the second feature vector representing the figure as the result of the response, to generate a result of association by the user.

Specifically, the computing unit 108 performs Fourier transform on the figure corresponding to the timbre different from the timbres of the representative sounds, and generates the second feature vector that is the frequency vector corresponding to the figure. The computing unit 108 then associates the first feature vector representing the timbre different from the timbres of the representative sounds with the second feature vector representing the figure, and generates a result of association by the user.

The computing unit 108 associates the result of association by each user obtained in this manner with the user ID, and stores the results into the result storage unit 110.

The information processing device 10 then converts the timbre of a sound generated by the user's musical instrument performance into a figure, on the basis of the result of association by each user.

First, the user inputs his/her user ID to the touch panel display 4. As the user ID is input, it becomes clear which association result should be referred to at the time of the figure generation described later.

When the user generates a sound, the microphone 6 then collects the subject timbre.

The acquisition unit 104 acquires data indicating the subject timbres collected by the microphone 6.

The computing unit 108 performs known frequency analysis on the data representing the subject timbre acquired by the acquisition unit 104, to generate spectrogram data representing the subject timbre.

The computing unit 108 then inputs the spectrogram data representing the subject timbre to the trained encoder stored in the trained model storage unit 106, to generate the first feature vector of the subject timbre.

The computing unit 108 then calculates the second feature vector from the first feature vector of the subject timbre by referring to the association result corresponding to the user's ID in the result storage unit 110. Note that, at this point of time, the second feature vector corresponding to the subject timbre is calculated by interpolating the association result. The computing unit 108 then generates a figure representing the subject timbre by performing inverse Fourier transform on the second feature vector.

As illustrated in FIG. 13F, a second feature vector is the frequency vector obtained by performing Fourier transform on a figure. Therefore, by performing inverse Fourier transform on the frequency vector, it is possible to restore the figure corresponding to the frequency vector.

The control unit 102 performs control so that the figure generated by the computing unit 108 is displayed on the touch panel display 4.

Next, the functions of the information processing system 1 according to the present embodiment are described.

First, when the information processing device 10 receives a predetermined instruction signal, the CPU 12 of the information processing device 10 reads an information processing program from the storage device 16, loads the information processing program into the memory 14, and executes the information processing program. As a result, the CPU 12 functions as each of the functional components of the information processing device 10, and the processing illustrated in FIGS. 131 and 13J is performed.

First, the user inputs his/her user ID to the information processing device 10 by manipulating the touch panel display 4.

In step S100, the acquisition unit 104 acquires the user ID.

In step S102, the computing unit 108 generates a map on which the first feature vector of each of the timbres is projected. In step S102, the computing unit 108 then selects the first feature vectors corresponding to the timbres of three representative sounds from the first feature vectors projected on the map.

In step S102, the computing unit 108 sets one of the three representative sounds selected in step S100.

In step S104, the control unit 102 controls the speaker 2 to output the one representative sound set in step S102.

In step S106, the control unit 102 controls the touch panel display 4 to display a plurality of figure candidates.

As the figure candidates are displayed on the touch panel display 4, the user selects a figure matching the impression of the timbre of the sound output from the speaker 2 in step S104.

In step S108, the acquisition unit 104 acquires the user's response result.

In step S110, the computing unit 108 determines whether results of responses about figures have been obtained from the user for all the three representative sounds. If results of responses about figures have been obtained from the user for all the three representative sounds, the processing proceeds to step S112. If there is a representative sound for which any result of a response about a figure has not been obtained from the user, on the other hand, the processing returns to step S102.

In step S112, the computing unit 108 performs Fourier transform on each of the figures of the representative sounds as the response results obtained in step S108, to generate each of the second feature vectors that are the frequency vectors corresponding to the figures.

In step S114, the computing unit 108 associates the first feature vectors of the timbres of the representative sounds with the second feature vectors representing the figures in the response results generated in step S112, and thus, generates a result of association by the user.

In step S116, the computing unit 108 associates the association result obtained in step S114 with the user ID acquired in step S100, and stores the association result of the user into the result storage unit 110.

In step S118, the computing unit 108 selects a sound different from the three representative sounds.

In step S120, the control unit 102 controls the speaker 2 to output the timbre of the sound selected in step S118.

In step S122, the computing unit 108 reads the association result from the result storage unit 110, and generates a candidate for the figure of the sound selected in step S118 on the basis of the association result. Specifically, in step S122, the frequency vector of the sound selected in step S118 is subjected to inverse Fourier transform, to generate a candidate for the figure of the sound selected in step S118.

In step S124, the control unit 102 controls the touch panel display 4 to display the figure candidate generated in step S122.

As the candidate for the figure of the sound is displayed on the touch panel display 4, the user corrects the figure candidate so as to match the impression of the timbre of the sound output from the speaker 2 in step S120.

In step S126, the acquisition unit 104 acquires the user's response result.

In step S128, a check is made to determine whether results of responses about figures have been obtained from the user for all the sounds whose figures are to be identified. If results of responses about figures have been obtained from the user for all the sounds whose figures are to be identified, the processing proceeds to step S130. If there is a sound for which any result of a response about a figure has not been obtained from the user, on the other hand, the processing returns to step S118.

In step S130, the computing unit 108 associates the first feature vectors of the timbres of the sounds obtained in step S118 with the second feature vectors representing the figures in the response results generated in step S112, and thus, generates a result of association by the user.

In step S132, the computing unit 108 associates the association result obtained in step S114 with the association result obtained in step S130 and the user ID acquired in step S100, and stores the association result of the user into the result storage unit 110.

When the information processing device 10 next receives a predetermined instruction signal, the CPU 12 of the information processing device 10 reads the information processing program from the storage device 16, loads the information processing program into the memory 14, and executes the information processing program. Thus, the CPU 12 functions as each of the functional components of the information processing device 10, and the processing illustrated in FIG. 13K is performed. Note that the processing illustrated in FIG. 13K is repeatedly performed every time a sound emitted from the user is obtained.

First, the user inputs his/her user ID to the information processing device 10 by manipulating the touch panel display 4. When the user generates a sound by playing a musical instrument or the like, the microphone 6 then collects the sound.

In step S200, the acquisition unit 104 acquires the timbre of the subject sound collected by the microphone 6.

In step S202, the computing unit 108 converts the timbre of the sound obtained in step S200 into spectrogram data.

In step S204, the computing unit 108 reads the trained encoder stored in the trained model storage unit 106, and inputs the spectrogram data obtained in step S202 to the trained encoder. A two-dimensional first feature vector output from the trained encoder is then acquired.

In step S206, the computing unit 108 reads the association result corresponding to the input user ID from the result storage unit 110. In step S206, the computing unit 108 then generates the second feature vector corresponding to step S204 by referring to the read association result. Note that, at this point of time, the second feature vector corresponding to the subject timbre is calculated by interpolating the association result.

In step S208, the computing unit 108 restores a figure from the second feature vector generated in step S206.

In step S210, the control unit 102 controls the touch panel display 4 to output the figure obtained in step S208.

FIG. 13L is a diagram illustrating a result in which each first feature vector of a plurality of first feature vectors is associated with a figure in a map on which the first feature vectors of a plurality of timbres are projected. As illustrated in FIG. 13L, a plurality of figures including figures F1, F2, and F3 are associated with the first feature vectors on the map.

Note that, when a figure is presented to the user, a figure as shown in FIG. 13L or 13M may be displayed on the touch panel display 4. In a case where a figure as shown in FIG. 13M is displayed on the touch panel display 4, the information processing device 10 causes the touch panel display 4 to display the map on which the respective first feature vectors of a plurality of timbres are projected, for example. When the user places a cursor on a point on the map, the information processing device 10 then generates the figure F1 corresponding to the plotted point located at the cursor, and causes the touch panel display 4 to display the figure F1. As a result, the user can easily understand the correspondence between the position on the map on which the respective first feature vectors of the plurality of timbres are projected and the figure.

The information processing device 10 according to the present embodiment generates the first feature vector from the data representing the subject timbre, using the method as described above. Also, the information processing device 10 calculates the second feature vector representing the figure from the first feature vector representing the subject timbre, on the basis of a result of association of the first feature vector to the second feature vector, which has been collected beforehand for each user. The information processing device 10 generates a figure representing a subject timbre from the calculated second feature vector, and outputs the generated figure. In this manner, the timbre can be converted into a figure on the basis of the user's perception.

Although a case where the VAE is used when the first feature vector is generated from the data representing the subject timbre and the frequency vector of the figure is the second feature vector has been described as an example in the above embodiment, it is not limited to this. Any method may be used as long as certain data can be converted into a vector by the method.

Although a case where a closed figure as shown in FIG. 3 is used has been described as an example in the above embodiment, it is not limited to this, and some other type of figure may be used. For example, a figure such as a wavy line may be used. Alternatively, a figure that cannot be drawn with one stroke (a figure such as a double circle) may be used.

Although a case where a result of association of the first feature vector representing the subject timbre with the second feature vector representing the figure is collected beforehand for each user has been described as an example in the above embodiment, it is not limited to this. For example, the second feature vector may be generated from the first feature vector, without collection of a result of association of the first feature vector with the second feature vector for each user.

Furthermore, it is also assumed that a trainee exercises aiming at a timbre a professional player has produced. In this case, the timbre produced by the professional layer is associated with a result of a response about a figure image of the timbre from the trainee, and thus, the first feature vector and the second feature vector are associated with each other. A figure imaged by the trainee is then generated from the timbre produced by the professional player. Alternatively, a figure that is generally imaged may be preset.

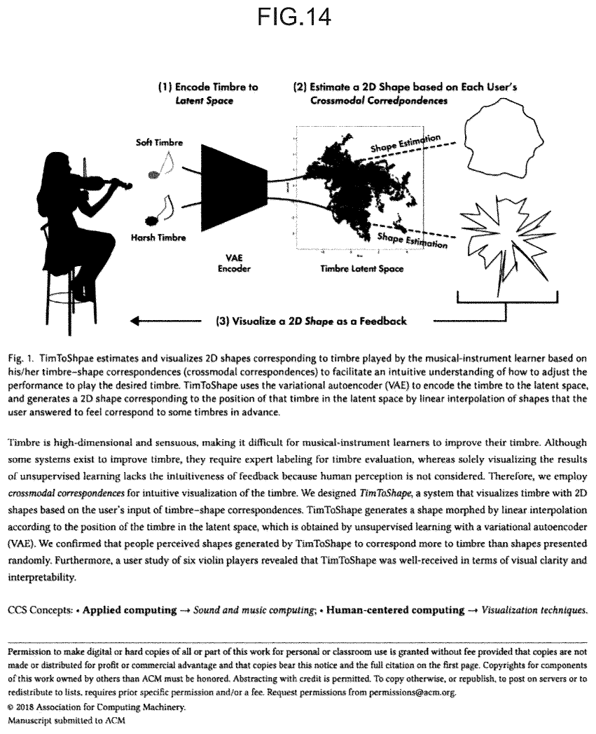

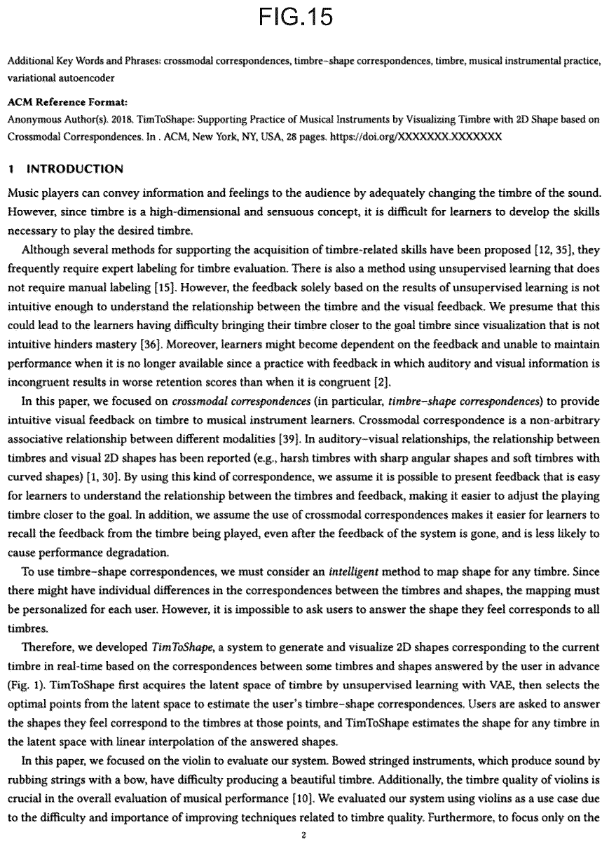

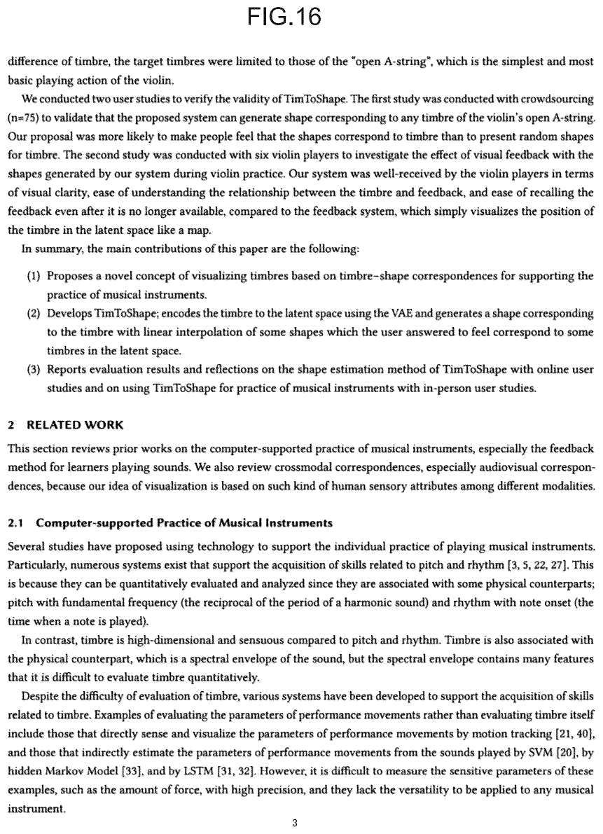

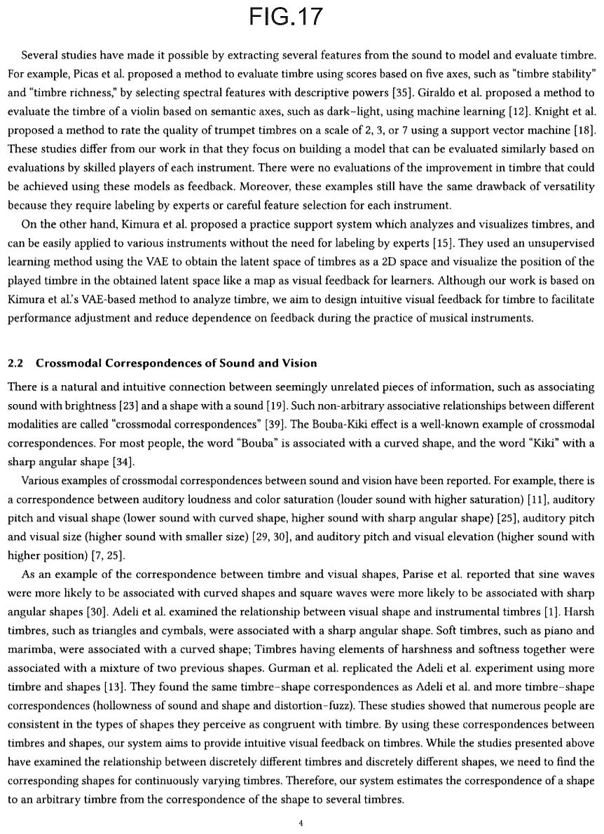

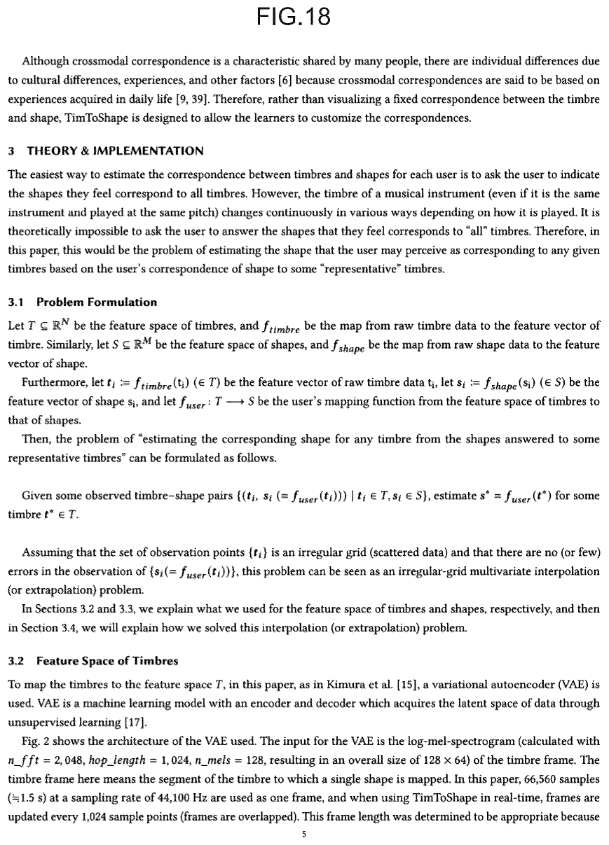

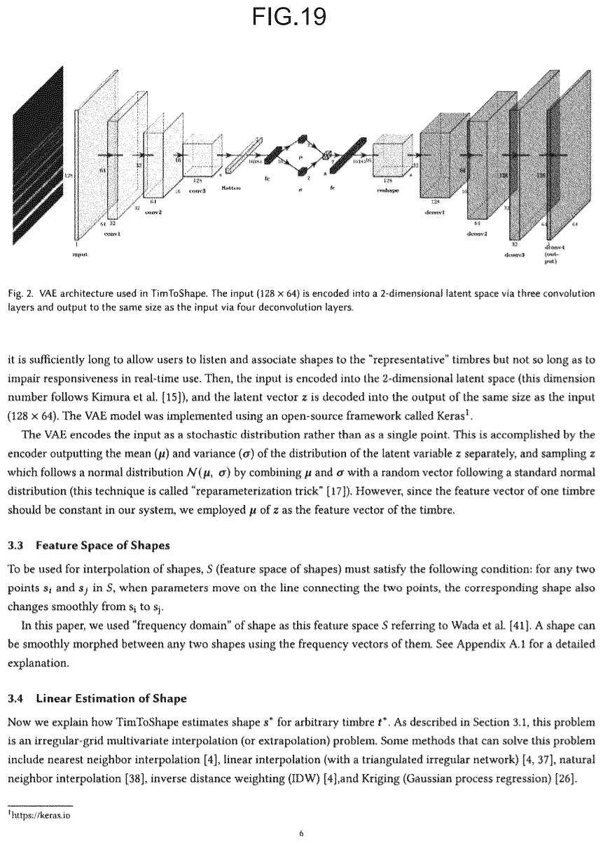

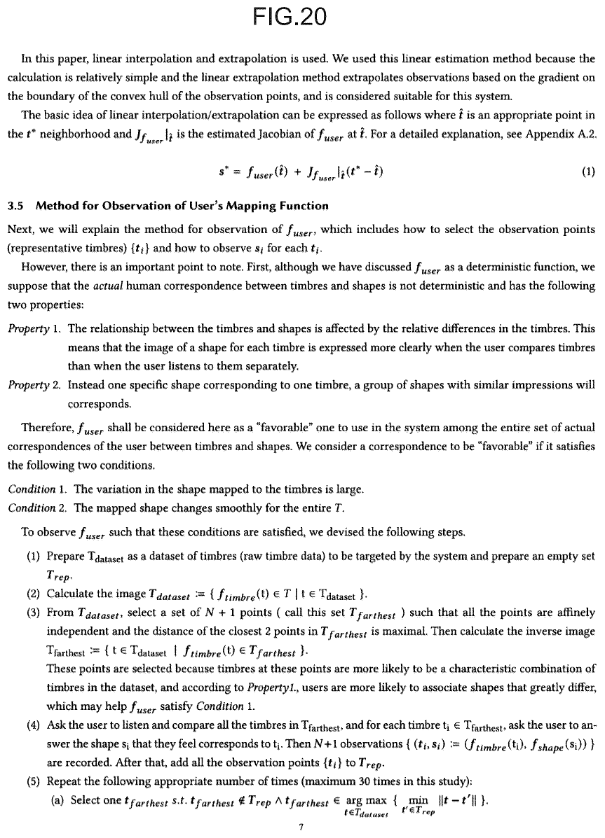

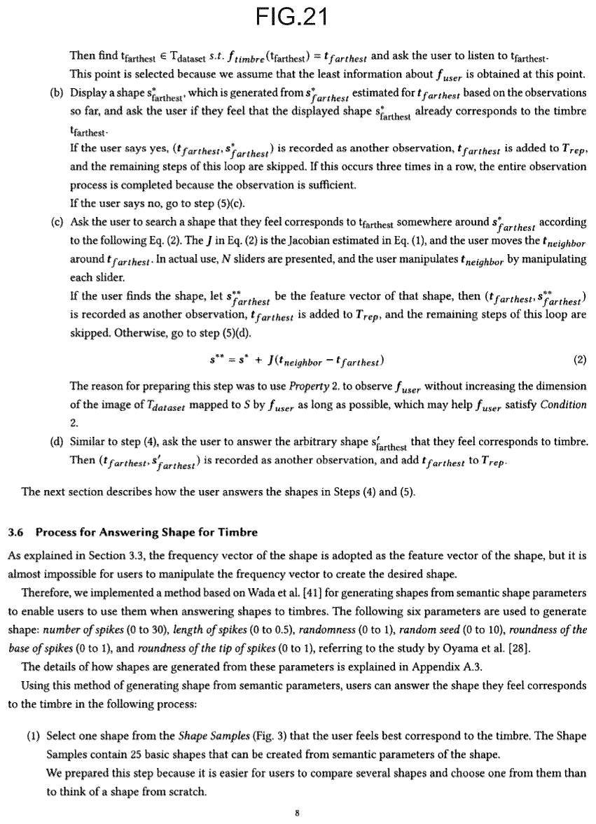

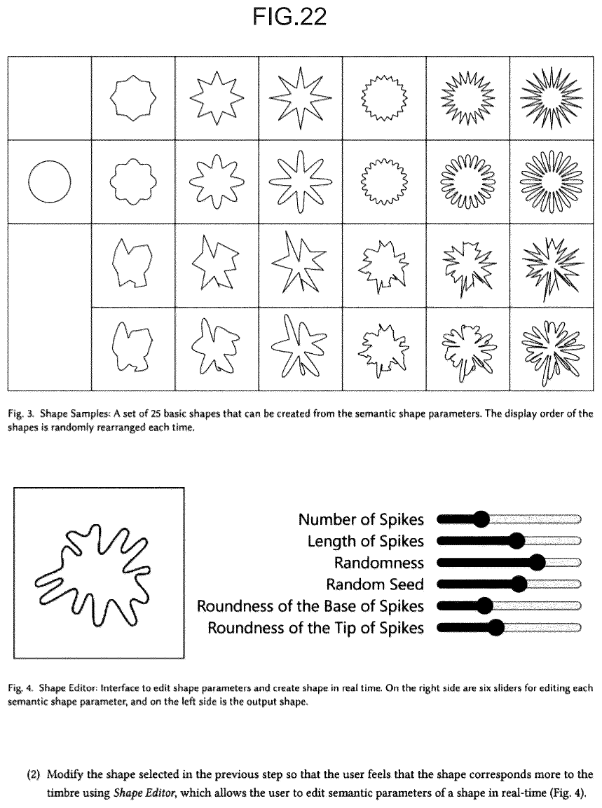

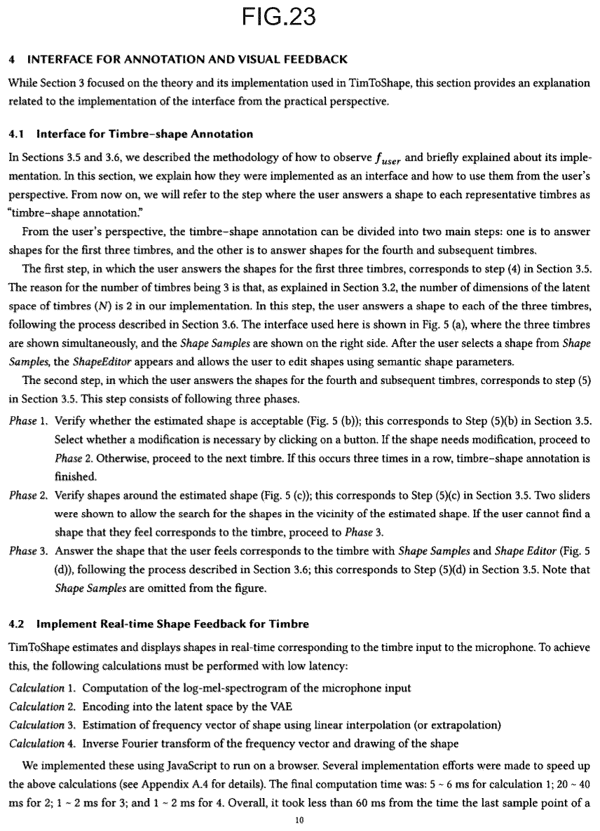

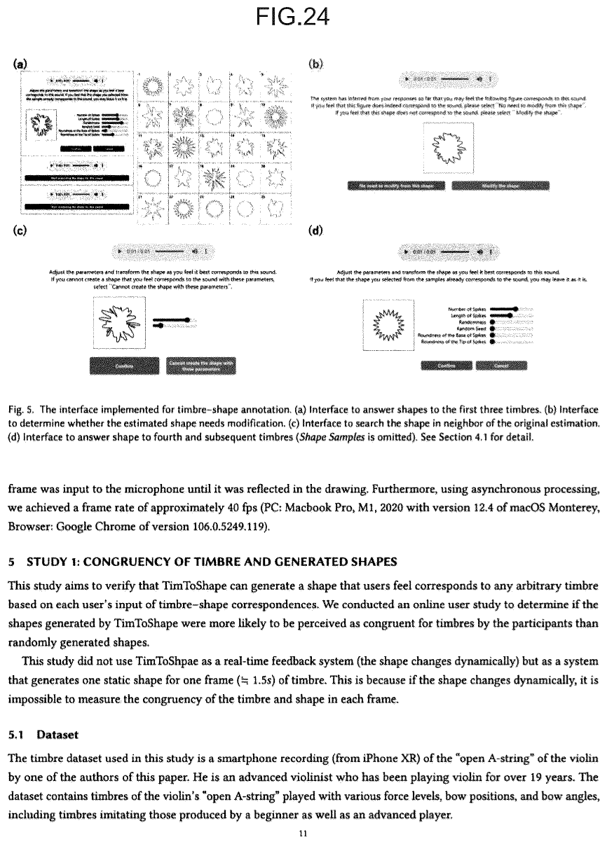

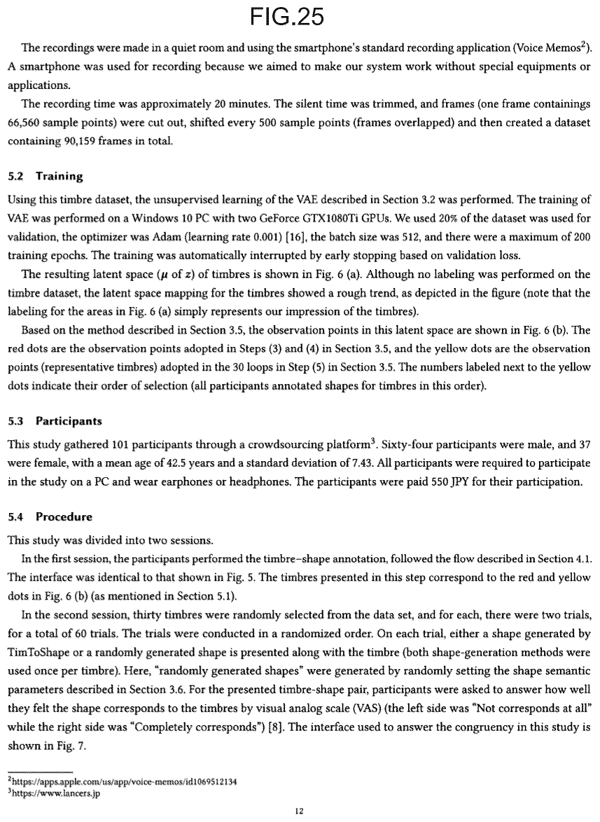

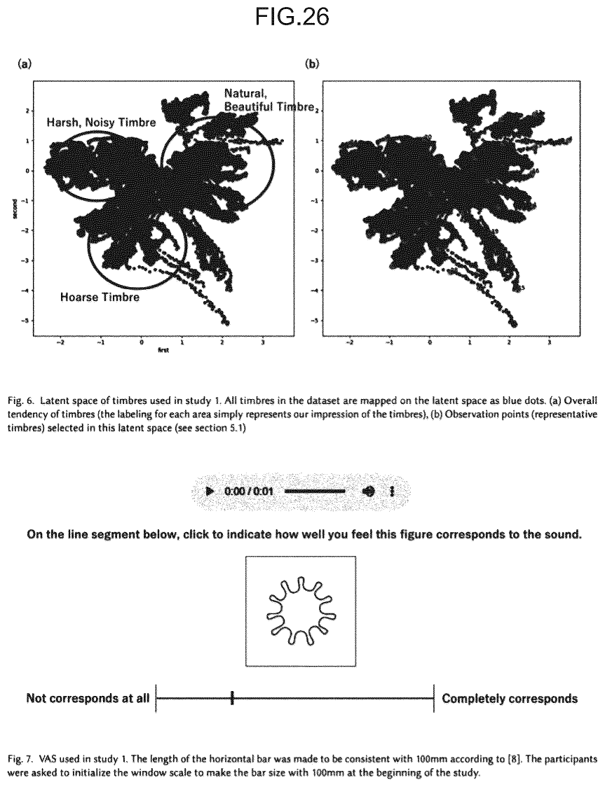

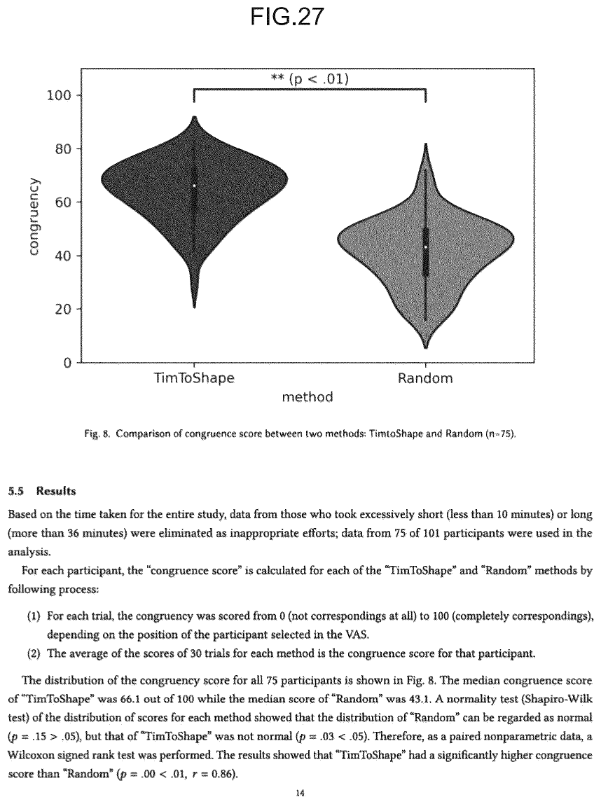

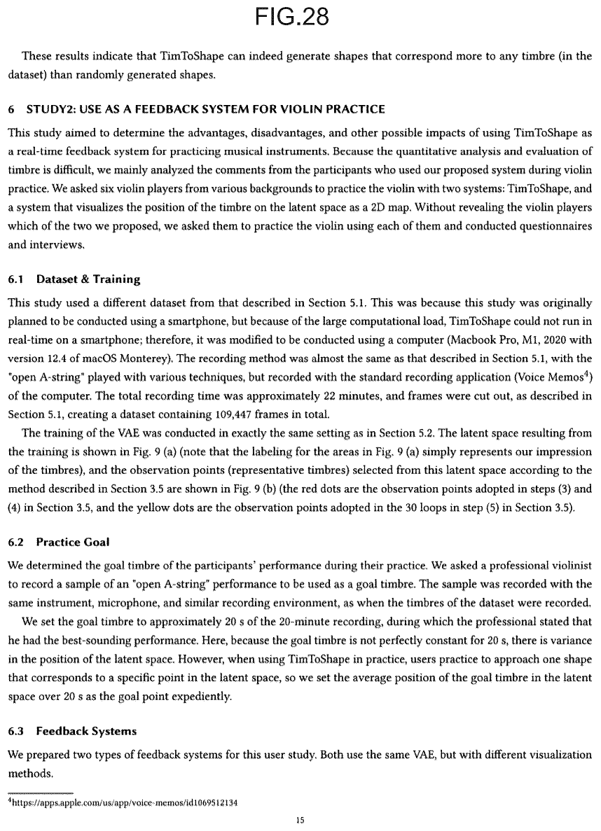

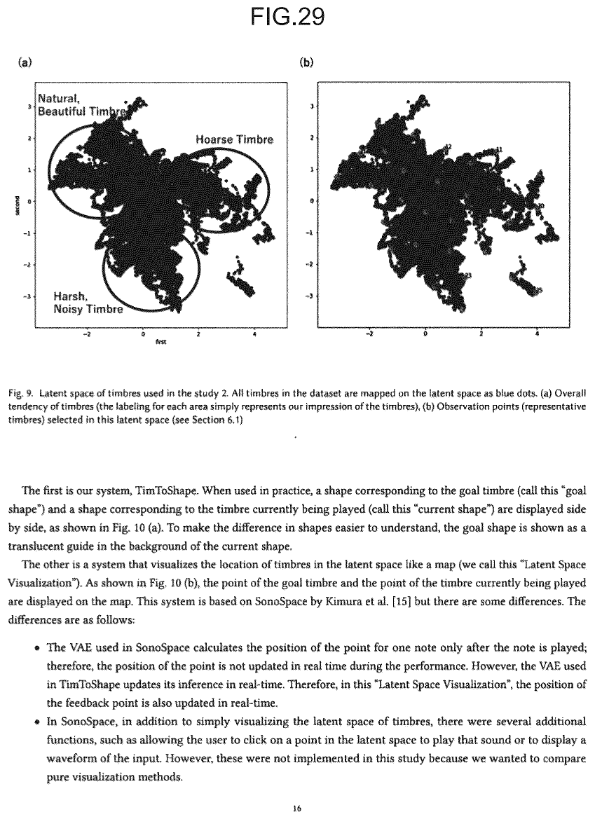

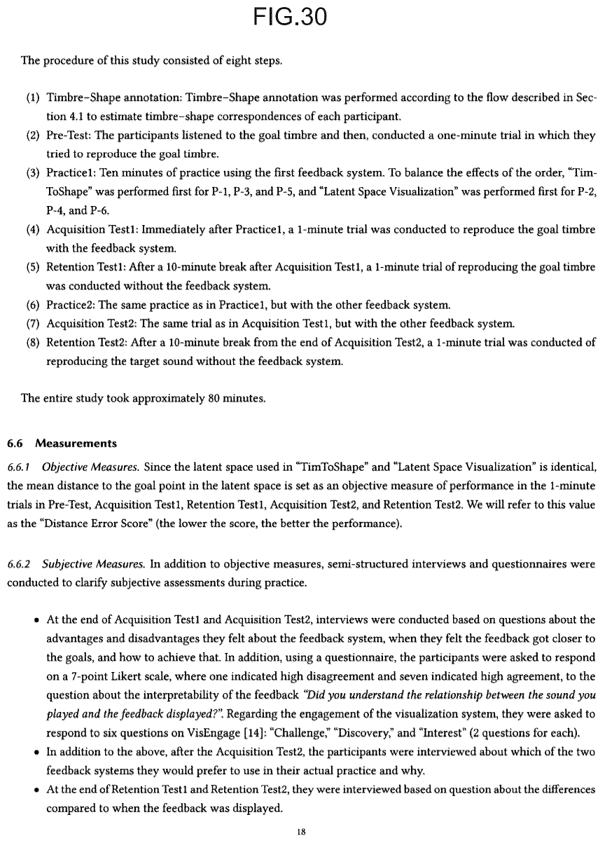

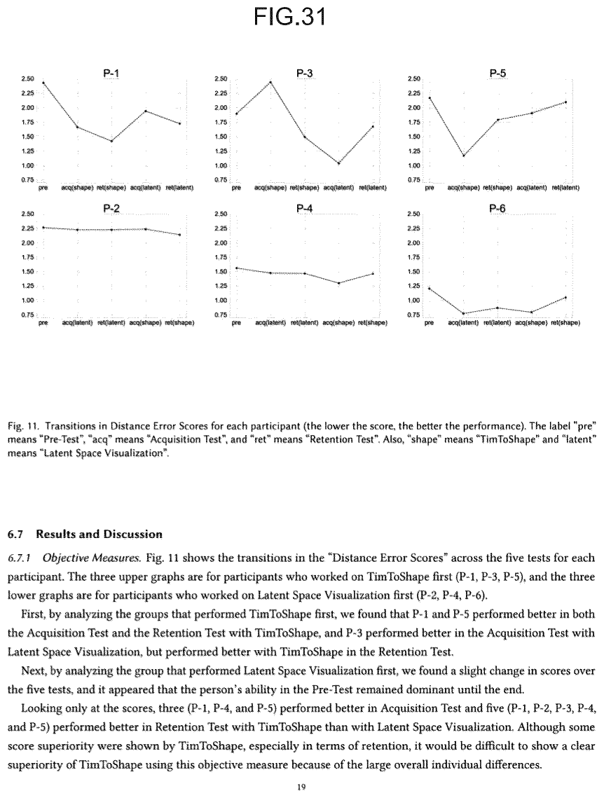

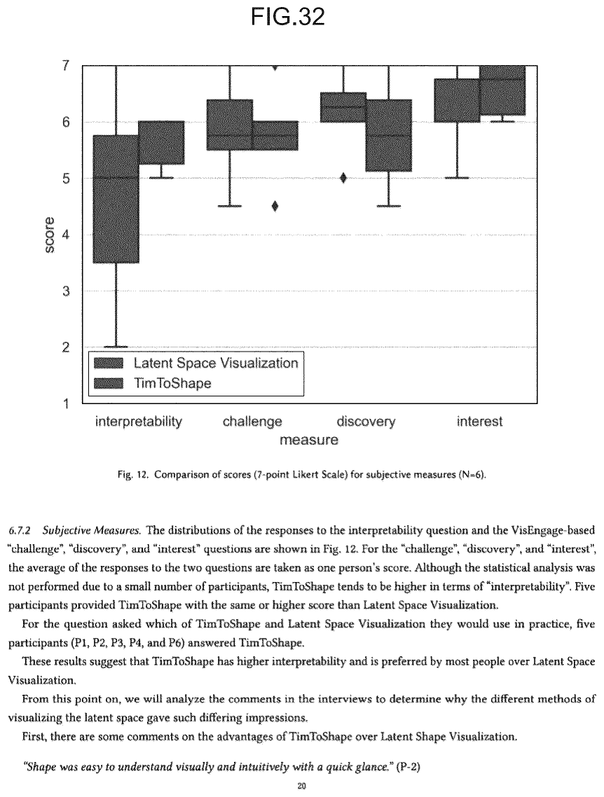

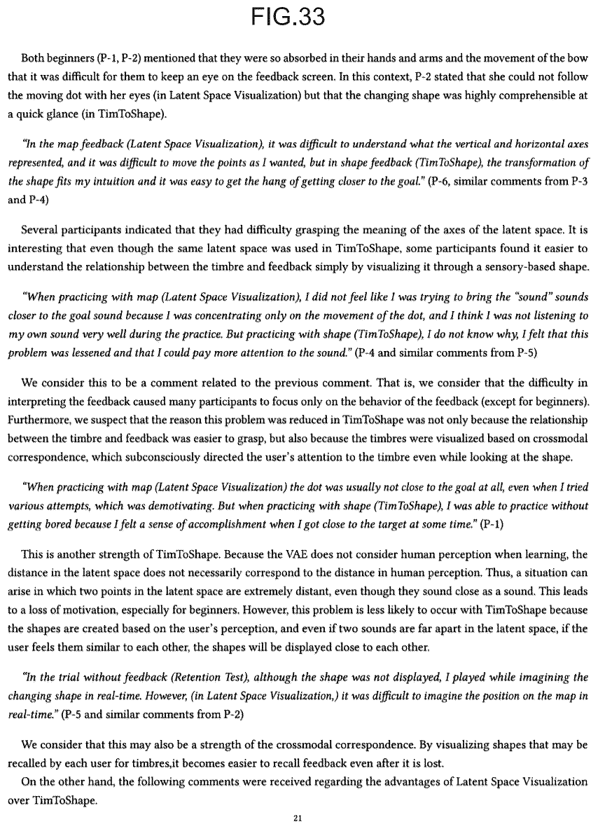

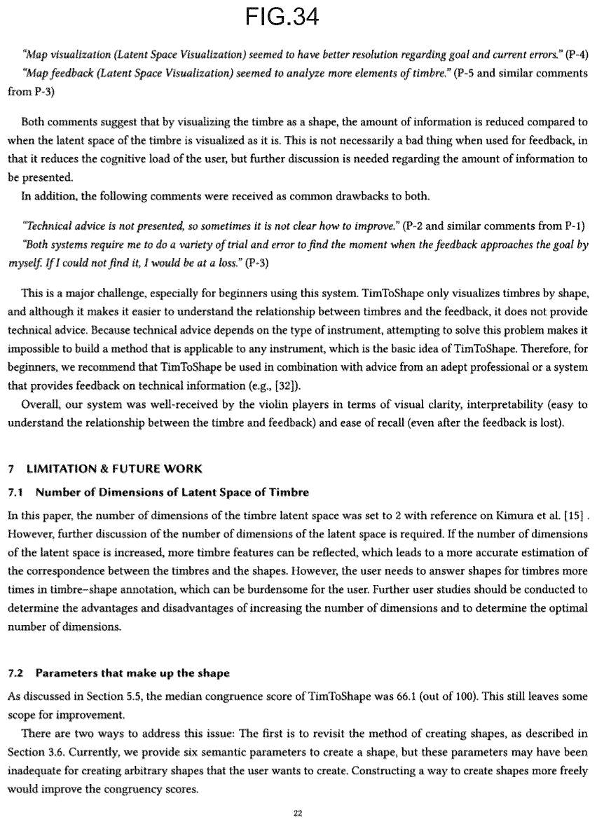

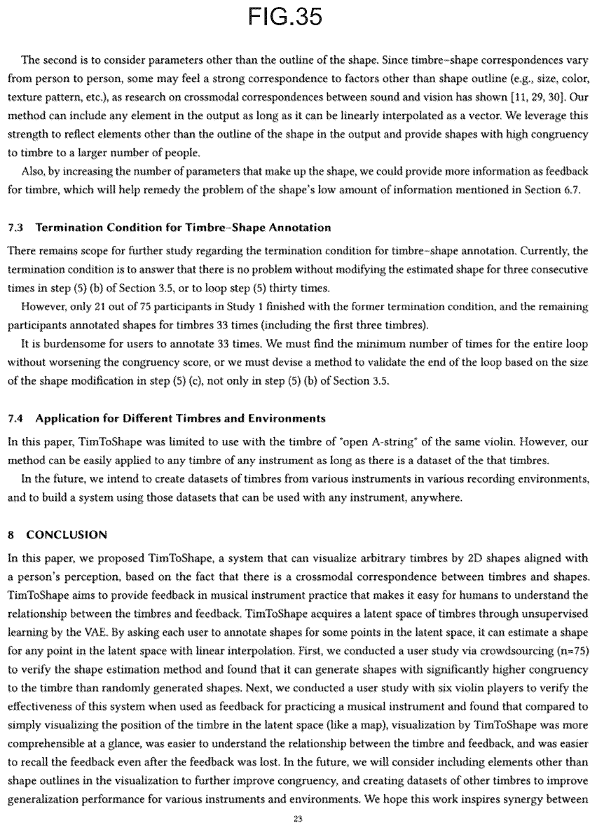

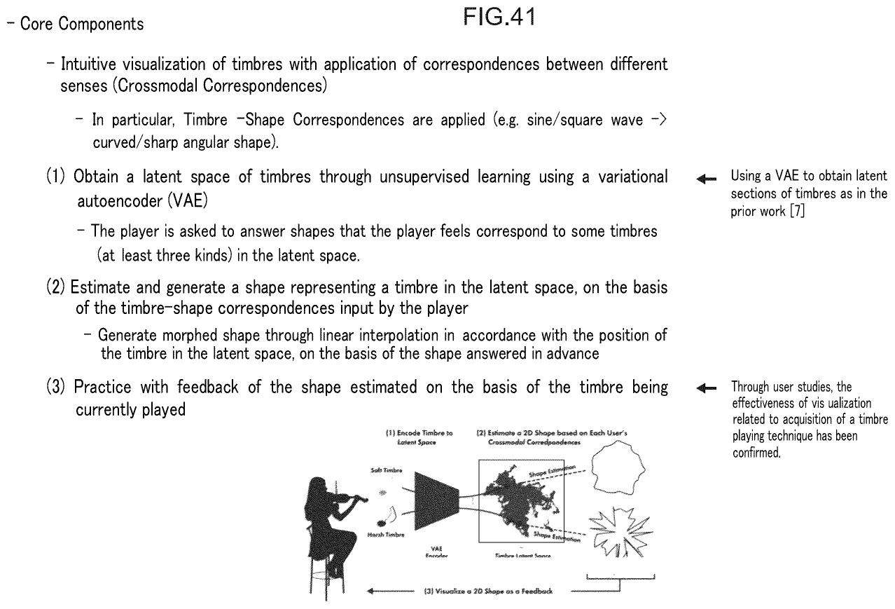

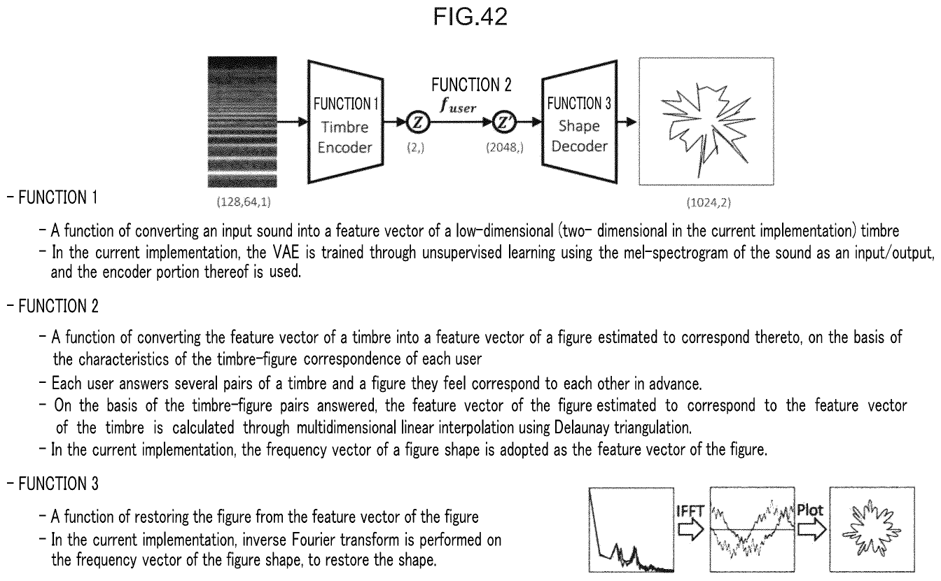

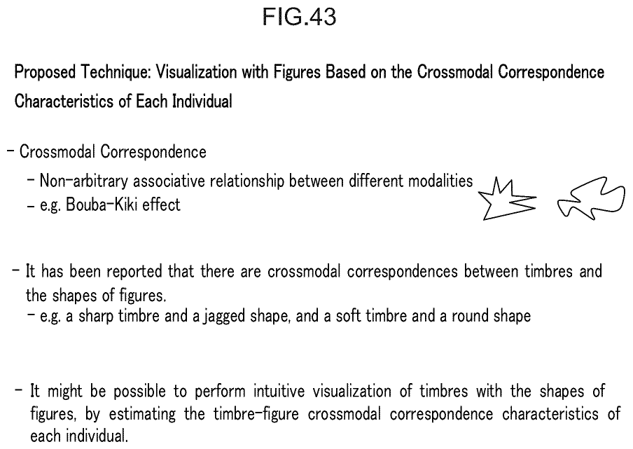

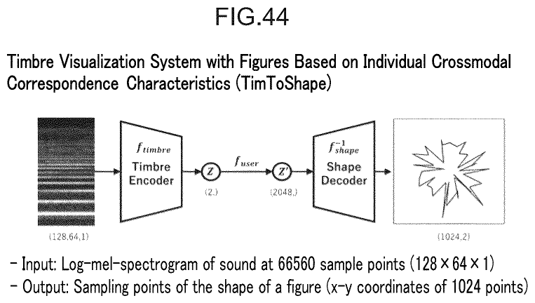

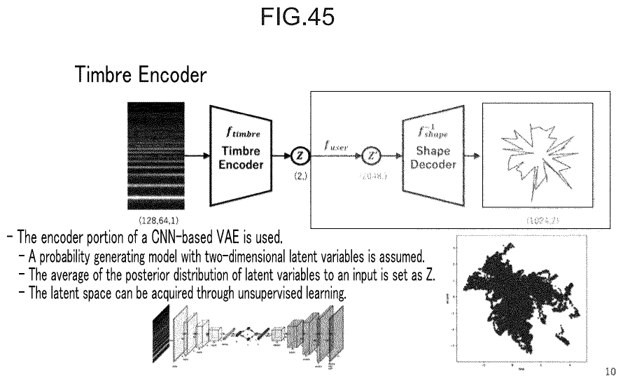

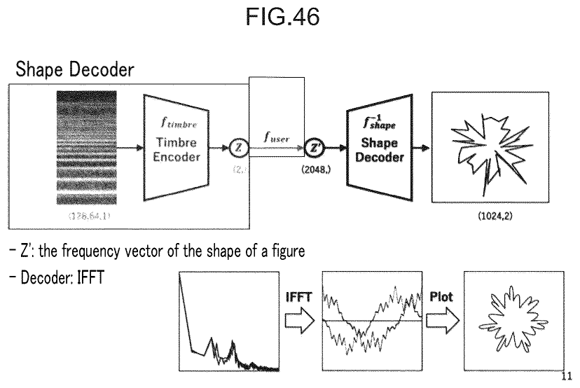

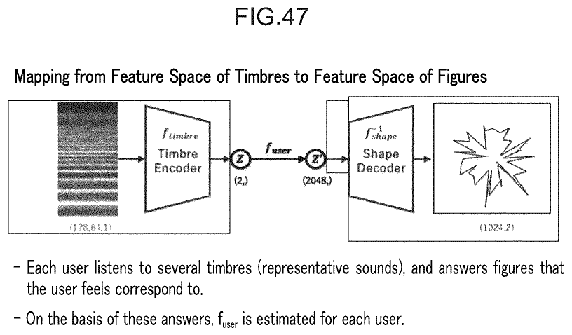

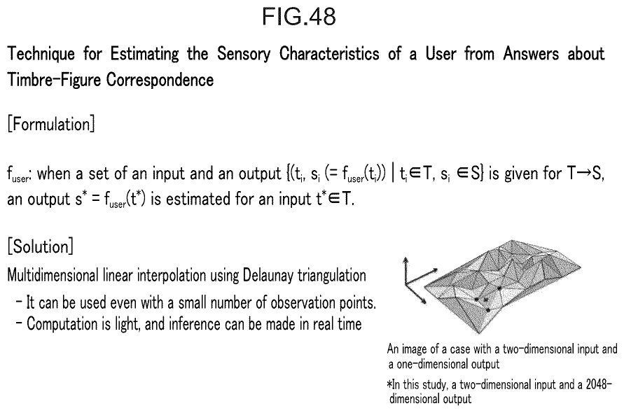

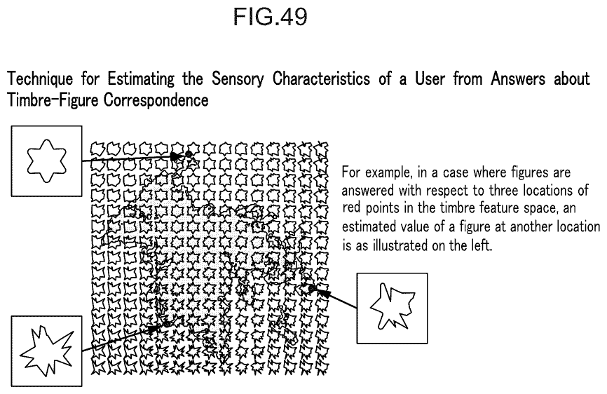

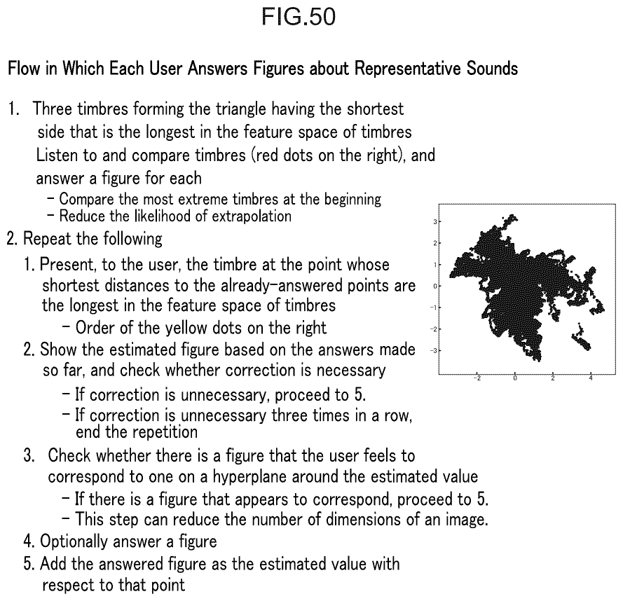

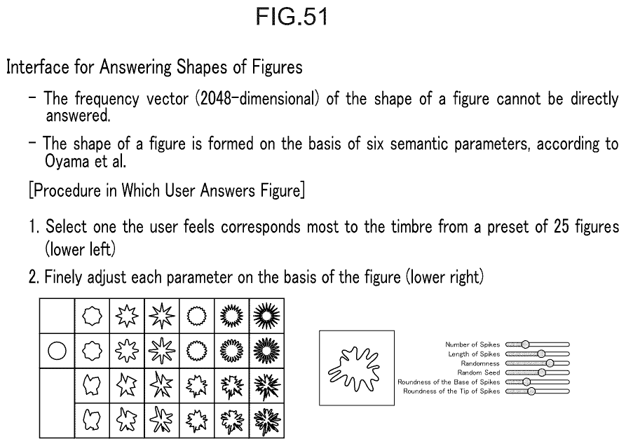

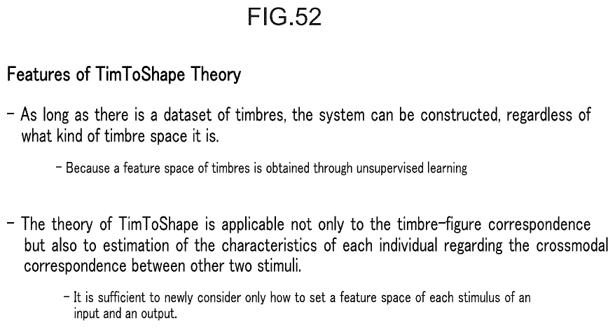

FIGS. 14 to 52 are charts for explaining the present embodiment in detail.

Alternatively, each sequence of processing performed by the CPU reading software (programs) in the above embodiment may be performed by various processors other than a CPU. Examples of the processors in this case include a programmable logic device (PLD) in which the circuit configuration can be changed after manufacturing, such as a field-programmable gate array (FPGA), and a dedicated electric circuit that is a processor having a circuit configuration designed exclusively for performing specific processing, such as an application specific integrated circuit (ASIC). Further, each sequence of processing may be performed by one of these various processors, or by a combination of two or more processors of the same type or different types (for example, a plurality of FPGAs, or a combination of a CPU and an FPGA). More specifically, the hardware structure of any of these various processors is an electric circuit in which circuit elements such as semiconductor elements are combined.

Although a mode in which each program is stored (installed, for example) beforehand into a storage device has been described in the above embodiment, it is not limited to this. The programs may be provided in a form stored in a storage medium such as a CD-ROM, a DVD-ROM, a Blu-ray Disc, or a USB memory. Alternatively, the programs may be downloaded from an external device via a network.

### (Supplementary Notes)

In the following, modes of the present disclosure are noted.

(Supplementary Note 1) An information processing device that
generates a first feature vector from data representing a subject timbre,
calculates a second feature vector representing a figure from the first feature vector representing the subject timbre, on the basis of a result of association of the first feature vector with the second feature vector,
generates a figure representing the subject timbre from the second feature vector, and
outputs the generated figure.

(Supplementary Note 2) The information processing device according to Supplementary Note 1, which
performs control so as to cause a sound output unit to output timbres of a plurality of representative sounds, and performs control so as to cause a display unit to display figure candidates corresponding to the respective timbres of the plurality of representative sounds,
obtains a result of response about a figure corresponding to each of the timbres of the plurality of representative sounds, the result of response being input from a user, and,
on the basis of the result of response, associates the first feature vectors of the timbres of the representative sounds with the second feature vectors representing the figures in the result of response, to generate the result of association.

(Supplementary Note 3) The information processing device according to Supplementary Note 2, which
generates a figure candidate corresponding to the second feature vector of a timbre different from the timbres of the representative sounds, by interpolating the result of association of the timbres of the plurality of representative sounds with the figures,
performs control so as to cause the sound output unit to output the timbre different from the timbres of the representative sounds, and performs control so as to cause the display unit to display the figure candidate corresponding to the second feature vector of the timbre different from the timbres of the representative sounds,
acquires a result of response about a figure corresponding to the timbre different from the timbres of the representative sounds, the result of response being input from the user, and,
on the basis of the result of response about the figure corresponding to the timbre different from the timbres of the representative sounds, associates the first feature vector of the timbre different from the timbres of the representative sounds with the second feature vector representing the figure in the result of response, to generate the result of association.

(Supplementary Note 4) The information processing device according to Supplementary Note 3, in which
the shape of the figure candidate that is displayed on the display unit and corresponds to the timbre different from the timbres of the representative sounds is correctable by the user.

(Supplementary Note 5) The information processing device according to Supplementary Note 2 or 3, which,
for each timbre of a plurality of timbres, inputs data representing the timbre to a trained model generated beforehand, to generate the first feature vector corresponding to the data representing the timbre,
generates a map on which the first feature vector of each timbre of the plurality of timbres is projected,
selects the first feature vectors corresponding to the timbres of the representative sounds from a plurality of the first feature vectors projected on the map,
performs Fourier transform on the figures of the representative sounds obtained from the result of response and the figure corresponding to the timbre different from the timbres of the representative sounds, to generate the second feature vectors that are frequency vectors corresponding to the figures, and generate the result of association, and,
when generating the figure representing the subject timbre,
generates the first feature vector of the subject timbre by inputting the data representing the subject timbre to the trained model,
calculates the second feature vector from the first feature vector of the subject timbre by referring to the result of association, and
generates the figure representing the subject timbre by performing inverse Fourier transform on the second feature vector.

(Supplementary Note 6) An information processing method implemented by a computer to perform processing including:
generating a first feature vector from data representing a subject timbre;
calculating a second feature vector representing a figure from the first feature vector representing the subject timbre, on the basis of a result of association of the first feature vector with the second feature vector; and
generating a figure representing the subject timbre from the second feature vector.

(Supplementary Note 7) An information processing program for causing a computer to perform processing including:
generating a first feature vector from data representing a subject timbre;
calculating a second feature vector representing a figure from the first feature vector representing the subject timbre, on the basis of a result of association of the first feature vector with the second feature vector; and
generating a figure representing the subject timbre from the second feature vector.

The disclosures of Japanese Patent Application No. 2023-015722, filed on Feb. 3, 2023, and Japanese Patent Application No. 2023-094415, filed on Jun. 7, 2023, are incorporated herein by reference in their entirety. All literatures, patent applications, and technical standards mentioned in this specification are incorporated herein by reference to the same extent as that in a case where each literature, each patent application, and each technical standard are specifically and individually mentioned to be incorporated by reference.

1. An information processing device that
generates a first feature vector from data representing a subject timbre,
calculates a second feature vector representing a figure from the first feature vector representing the subject timbre, on a basis of a result of association of the first feature vector with the second feature vector,
generates a figure representing the subject timbre from the second feature vector, and
outputs the generated figure.

2. The information processing device according to claim 1, which
performs control to cause a sound output unit to output timbres of a plurality of representative sounds, and performs control to cause a display unit to display figure candidates corresponding to the respective timbres of the plurality of representative sounds,
obtains a result of response about a figure corresponding to each of the timbres of the plurality of representative sounds, the result of response being input from a user, and,
on a basis of the result of response, associates the first feature vectors of the timbres of the representative sounds with the second feature vectors representing the figures in the result of response, to generate the result of association.

3. The information processing device according to claim 2, which generates a figure candidate corresponding to the second feature vector of a timbre different from the timbres of the representative sounds, by interpolating the result of association of the timbres of the plurality of representative sounds with the figures,
performs control to cause the sound output unit to output the timbre different from the timbres of the representative sounds, and performs control to cause the display unit to display the figure candidate corresponding to the second feature vector of the timbre different from the timbres of the representative sounds,
acquires a result of response about a figure corresponding to the timbre different from the timbres of the representative sounds, the result of response being input from the user, and,
on a basis of the result of response about the figure corresponding to the timbre different from the timbres of the representative sounds, associates the first feature vector of the timbre different from the timbres of the representative sounds with the second feature vector representing the figure in the result of response, to generate the result of association.

4. The information processing device according to claim 3, wherein
a shape of the figure candidate that is displayed on the display unit and corresponds to the timbre different from the timbres of the representative sounds is correctable by the user.

5. The information processing device according to claim 2, which,
for each timbre of a plurality of timbres, inputs data representing the timbre to a trained model generated beforehand, to generate the first feature vector corresponding to the data representing the timbre,
generates a map on which the first feature vector of each timbre of the plurality of timbres is projected,
selects the first feature vectors corresponding to the timbres of the representative sounds from a plurality of the first feature vectors projected on the map,
performs Fourier transform on the figures of the representative sounds obtained from the result of response and the figure corresponding to the timbre different from the timbres of the representative sounds, to generate the second feature vectors that are frequency vectors corresponding to the figures, and generate the result of association, and,
when generating the figure representing the subject timbre,
generates the first feature vector of the subject timbre by inputting the data representing the subject timbre to the trained model,
calculates the second feature vector from the first feature vector of the subject timbre by referring to the result of association, and
generates the figure representing the subject timbre by performing inverse Fourier transform on the second feature vector.

6. An information processing method implemented by a computer to perform processing including:
generating a first feature vector from data representing a subject timbre;
calculating a second feature vector representing a figure from the first feature vector representing the subject timbre, on a basis of a result of association of the first feature vector with the second feature vector; and
generating a figure representing the subject timbre from the second feature vector.

7. A non-transitory storage medium storing an information processing program that is executable by a computer to perform processing including:
generating a first feature vector from data representing a subject timbre;
calculating a second feature vector representing a figure from the first feature vector representing the subject timbre, on a basis of a result of association of the first feature vector with the second feature vector; and
generating a figure representing the subject timbre from the second feature vector.
